(19) United States
(12) Patent Application Publication
(10) Pub. No.: US 2024/0104371 A1
(43) Pub. Date: Mar. 28, 2024

(54) COOPERATIVE LEARNING OF LANGEVIN FLOW AND NORMALIZING FLOW TOWARD ENERGY-BASED MODEL

(71) Applicant: Baidu USA, LLC, Sunnyvale, CA (US)

(72) Inventors: Jianwen XIE, Santa Clara, CA (US); Yaxuan ZHU, Los Angeles, CA (US); Jun LI, Shanghai (CN); Ping LI, Bellevue, WA (US)

(73) Assignee: Baidu USA LLC, Sunnyvale, CA (US)

(21) Appl. No.: 17/947,963

(22) Filed: Sep. 19, 2022

(51) Int. Cl. G06N 3/08; G06N 3/04

(52) U.S. Cl. CPC G06N 3/08; G06N 3/0472

(57) ABSTRACT

Embodiments of a generative framework comprise cooperative learning of two generative flow models, in which the two models are iteratively updated based on the jointly synthesized examples. In one or more embodiments, the first flow model is a normalizing flow that transforms an initial simple density into a target density by applying a sequence of invertible transformations, and the second flow model is a Langevin flow that runs finite steps of gradient-based MCMC toward an energy-based model. In learning iterations, synthesized examples are generated by using a normalizing flow initialization followed by a short-run Langevin flow revision toward the current energy-based model. Then, the synthesized examples may be treated as fair samples from the energy-based model and the model parameters are updated, while the normalizing flow directly learns from the synthesized examples by maximizing the tractable likelihood. Also provided are both theoretical and empirical justifications for the embodiments.

### BACKGROUND

### A. Technical Field

The present disclosure relates generally to systems and methods for computer learning that can provide improved computer performance, features, and uses. More particularly, the present disclosure relates to systems and methods for cooperative learning of generative flow models.

### B. Background

Normalizing flows are a family of generative models that construct a complex distribution by transforming a simple probability density, such as Gaussian distribution, through a sequence of invertible and differentiable mappings. However, for the sake of ensuring the favorable property of closed-form density evaluation, normalizing flows typically require special designs of the sequence of transformations, which, in general, constrain the expressive power of the models.

Energy-based models (EBMs) define an unnormalized probability density function of data, which is the exponential of the negative energy function. The energy function may be directly defined on a data domain and assigns each input configuration with a scalar energy value, with lower energy values indicating more likely configurations. However, due to the intractable integral in computing the normalizing constant, the evaluation of the gradient of the log-likelihood typically requires approaches to address the intractability to generate samples from the current model. But, the sampling on a highly multi-modal energy function, due to the use of deep network parameterization, is generally not mixing. An estimated gradient of the likelihood may be biased, and a resulting learned EBM may be an invalid model, which is unable to approximate the data distribution as expected.

Given that sampling for EBMs is not mixing and may not be a way of training a valid EBM of data, what is needed are different methodologies for producing good generative models.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures may not be to scale.

FIG. 1 depicts a CoopFlow methodology, according to embodiments of the present disclosure.

FIG. 2 depicts another CoopFlow methodology, according to embodiments of the present disclosure.

FIG. 3 depicts a methodology for using a trained CoopFlow model as a generator, according to embodiments of the present disclosure.

FIG. 4 depicts an illustration of model distributions that correspond to different parameters at convergence, according to embodiments of the present disclosure.

FIGS. 5A & 5B depict learning CoopFlows on two-dimensional data, according to embodiments of the present disclosure.

FIGS. 6A and 6B show the FID (Fréchet Inception Distance) trends during the training of CoopFlow model embodiments on a dataset, according to embodiments of the present disclosure.

FIG. 7 depicts reconstruction errors (mean squared error (MSE) per pixel) over iterations, according to embodiments of the present disclosure.

FIG. 8 depicts a graphical comparison between a CoopFlow embodiment and a short-run EBM, according to embodiments of the present disclosure.

FIG. 9 depicts a simplified block diagram of a computing device/information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgment, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The terms “include,” “including,” “comprise,” “comprising,” or any of their variants shall be understood to be open terms, and any lists of items that follow are example items and not meant to be limited to the listed items. A “layer” may comprise one or more operations. The words “optimal,” “optimize,” “optimization,” and the like refer to an improvement of an outcome or a process and do not require that the specified outcome or process has achieved an “optimal” or peak state. The use of memory, database, information base, data store, tables, hardware, cache, and the like may be used herein to refer to system component or components into which information may be entered or otherwise recorded. A set may contain any number of elements, including the empty set.

In one or more embodiments, a stop condition may include: (1) a set number of iterations have been performed; (2) an amount of processing time has been reached; (3) convergence (e.g., the difference between consecutive iterations is less than a threshold value); (4) divergence (e.g., the performance deteriorates); (5) an acceptable outcome has been reached; and (6) all of the data has been processed.

One skilled in the art shall recognize that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

It shall also be noted that although embodiments described herein may be within the context of images, aspects of the present disclosure are not so limited. Accordingly, aspects of the present disclosure may be applied or adapted for use in other contexts and using other signals.

### A. General Introduction

As discussed above, normalizing flows are a family of generative models that construct a complex distribution by transforming a simple probability density, such as Gaussian distribution, through a sequence of invertible and differentiable mappings. Due to the tractability of the exact log-likelihood and the efficiency of the inference and synthesis, normalizing flows have gained popularity in density estimation and variational inference. However, for the sake of ensuring the favorable property of closed-form density evaluation, the normalizing flows typically require special designs of the sequence of transformations, which, in general, constrain the expressive power of the models.

Also as mentioned previously, energy-based models (EBMs) define an unnormalized probability density function of data, which is the exponential of the negative energy function. The energy function is directly defined on data domain, and assigns each input configuration with a scalar energy value, with lower energy values indicating more likely configurations. Recently, with the energy function parameterized by a modern deep network such as a ConvNet, the ConvNet-EBMs have gained unprecedented success in modeling large-scale data sets and exhibited stunning performance in synthesizing different modalities of data, e.g., videos, volumetric shapes, point clouds, and molecules. The parameters of the energy function may be trained by maximum likelihood estimation (MLE). However, due to the intractable integral in computing the normalizing constant, the evaluation of the gradient of the loglikelihood typically requires Markov chain Monte Carlo (MCMC) sampling, e.g., Langevin dynamics, to generate samples from the current model. However, the Langevin sampling on a highly multi-modal energy function, due to the use of deep network parameterization, is generally not mixing. When sampling from a density with a multi-modal landscape, the Langevin dynamics, which follows the gradient information, is apt to get trapped by local modes of the density and is unlikely to jump out and explore other isolated modes. Relying on non-mixing MCMC samples, the estimated gradient of the likelihood is biased, and the resulting learned EBM may become an invalid model, which is unable to approximate the data distribution as expected.

Recently, it has been proposed to train an EBM with a short-run non-convergent Langevin dynamics, and it was shown that even though the energy function is invalid, the short-run MCMC may be treated as a valid flow-like model that generates realistic examples. This not only provides an explanation of why an EBM with a non-convergent MCMC is still capable of synthesizing realistic examples, but also suggests a more practical computationally-affordable way to learn useful generative models under the existing energy-based frameworks. Although EBMs have been widely applied to different domains, learning short-run MCMC in the context of EBM is still underexplored.

In this patent document, it is accepted that MCMC sampling is not mixing in practice, and the goal of training a valid EBM of data is abandoned. Instead, embodiments treat the short-run non-convergent Langevin dynamics, which shares parameters with the energy function, as a flow-like transformation that may be referred to herein as the Langevin flow because it may be considered a noise-injected residual network. Even though implementing a short-run Langevin flow may be considered to be simple, which may be but a design of a bottom-up ConvNet for the energy function, it might still require a sufficiently large number of Langevin steps (each Langevin step comprises one step of gradient descent and one step of diffusion) to construct an effective Langevin flow, so that it can be expressive enough to represent the data distribution. Motivated by reducing the number of Langevin steps in the Langevin flow for computational efficiency, presented herein are embodiments (which may be referred to generally, for convenience, as CoopFlow models, CoopFlow, or CoopFlow embodiments) that train a Langevin flow jointly with a normalizing flow in a cooperative learning scheme, in which the normalizing flow learns to serve as a rapid sampler to initialize the Langevin flow so that the Langevin flow can be shorter, while the Langevin flow teaches the normalizing flow by short-run MCMC transition toward the EBM so that the normalizing flow can accumulate the temporal difference in the transition to provide better initial samples. Compared to another cooperative learning framework that incorporates an MLE method of an EBM and an MLE method of a generator, the CoopFlow embodiments benefit from using a normalizing flow instead of a generic generator because the MLE of a normalizing flow generator is much more tractable than the MLE of any other generic generator. The latter might resort to either MCMC-based inference to evaluate the posterior distribution or another encoder network for variational inference. Besides, in the CoopFlow embodiments, the Langevin flow can overcome the expressivity limitation of the normalizing flow caused by invertibility constraint. Also, the understanding of the dynamics of cooperative learning with short-run non-mixing MCMC by information geometry is also furthered by the discussions herein. A justification is provided that a CoopFlow embodiment trained in the context of EBM with non-mixing MCMC is a valid generator because it converges to a moment matching estimator. Experiments, including image generation, image reconstruction, and latent space interpolation, are conducted to support the justification.

### B. Some Related Work

The following discussion presents some related work. Some of the differences between embodiments of the current patent document and the prior approaches are mentioned to further highlight some of the contributions and novelties of the inventive aspects of embodiments.

### 1. Learning Short-Run MCMC as a Generator

Recently, it was proposed to learn an EBM with short-run non-convergent MCMC that samples from the model, and the short-run MCMC as a valid generator and discard the biased EBM. Other used short-run MCMC to sample the latent space of a top-down generative model in a variational learning framework. Yet others (in commonly-owned U.S. patent application Ser. No. 17/343,477 (Docket No. 28888-2496 (BN210510USN5)), titled “LEARNING DEEP LATENT VARIABLE MODELS BY SHORT-RUN MCMC INFERENCE WITH OPTIMAL TRANSPORT CORRECTION,” filed on 9 Jun. 2021, and listing Jianwen Xie, Dongsheng An, and Ping Li as inventors (which patent document is incorporated by reference herein in its entirety)) proposed to correct the bias of the short-run MCMC inference by optimal transport in training latent variable models. Some adopted short-run MCMC to sample from both the EBM prior and the posterior of the latent variables. Embodiments herein study learning a normalizing flow to amortize the sampling cost of a short-run non-mixing MCMC sampler (i.e., Langevin flow) in data space, which makes a further step forward in this underexplored theme.

### 2. Cooperative Learning with MCMC Teaching

Embodiments of the learning methodology presented herein may be considered related to the CoopNets, in which an ConvNet-EBM and a top-down generator are jointly trained by jump-starting their maximum learning algorithms. In co-pending and commonly owned U.S. patent application Ser. No. 17/538,635 (Docket No. 28888-2542 (BN211021USN2)), titled “LEARNING ENERGY-BASED MODEL WITH VARIATIONAL AUTO-ENCODER AS AMORTIZED SAMPLER,” filed on 30 Nov. 2021, and listing Jianwen Xie, Zilong Zheng, and Ping Li as inventors (which patent document is incorporated by reference herein in its entirety) replaces the generator in the original CoopNets by a variational autoencoder (VAE) for efficient inference. Embodiments of the CoopFlow methodology are different from the above prior works in at least the following two aspects. First, in the idealized long-run mixing MCMC scenario, embodiments are a cooperative learning framework that trains an unbiased EBM and a normalizing flow via MCMC teaching, where updating a normalizing flow with a tractable density is more efficient and less biased than updating a generic generator via variational inference as in U.S. patent application Ser. No. 17/538,635 or MCMC-based inference as in Xie et al. (Jianwen Xie, Yang Lu, Ruiqi Gao, Song-Chun Zhu, and Ying Nian Wu. Cooperative Training of Descriptor and Generator Networks. IEEE Transactions On Pattern Analysis And Machine Intelligence (TPAMI), 42(1):27-45, 2020, which is incorporated by reference herein in its entirety). Second, the current patent document has a novel emphasis on cooperative learning with short-run non-mixing MCMC, which is more practical and common in reality. One or more embodiments train a short-run Langevin flow and a normalizing flow together toward a biased EBM for image generation. Information geometry is used to understand the learning dynamics, and it is shown that a learned two-flow generator embodiment (i.e., a CoopFlow embodiment) is a valid generative model, even though the learned EBM is biased.

### 3. Joint Training of EBM and Normalizing Flow

Two other works studied an EBM and a normalizing flow together. To avoid MCMC, some proposed to train an EBM using noise contrastive estimation, where the noise distribution is a normalizing flow. Others proposed to learn an EBM as an exponential tilting of a pretrained normalizing flow, so that neural transport MCMC sampling in the latent space of the normalizing flow can mix well. Embodiments herein train an EBM and a normalizing flow via short-run MCMC teaching. More specifically, a focus is on short-run non-mixing MCMC, and it is treated as a valid flow-like model (e.g., short-run Langevin flow) that is guided by the EBM. Disregarding the biased EBM, the resulting valid generator is the combination of the short-run Langevin flow and the normalizing flow, where the latter serves as a rapid initializer of the former. The form of this two-flow generator may be considered to share somewhat some similarity with the Stochastic Normalizing Flow, which consists of a sequence of deterministic invertible transformations and stochastic sampling blocks, but as is detailed below, there are significant differences.

### C. Two Flow Model Embodiments

By way of general overview, embodiments herein comprise cooperative learning of two generative flow models, in which the two models are iteratively updated based on the jointly synthesized examples. In one or more embodiments, the first flow model is a normalizing flow that transforms an initial simple density into a target density by applying a sequence of invertible transformations, and the second flow model is a Langevin flow that runs finite steps of gradient-based MCMC toward an energy-based model. Embodiments of a generative framework train an energy-based model with a normalizing flow as an amortized sampler to initialize the MCMC chains of the energy-based model. In each learning iteration, synthesized examples are generated by using a normalizing flow initialization followed by a short-run Langevin flow revision toward the current energy-based model. Then, the synthesized examples are treated as fair samples from the energy-based model and the model parameters are updated with a maximum likelihood learning gradient, while the normalizing flow directly learns from the synthesized examples by maximizing the tractable likelihood. Under the short-run non-mixing MCMC scenario, the estimation of the energy-based model is shown to follow the perturbation of maximum likelihood, and the short-run Langevin flow and the normalizing flow form a two-flow generator, which may be referred to as CoopFlow. An understating of the CoopFlow methodology is provided by information geometry, and it is shown that it is a valid generator as it converges to a moment matching estimator. It was also demonstrated that the trained CoopFlow is capable of synthesizing realistic images, reconstructing images, and interpolating between images. Before providing a more detailed explanation of CoopFlow embodiments, information about Langevin Flows and Normalizing Flows are first presented.

### 1. Langevin Flow Embodiments

### a) Energy-Based Model Embodiments

Let x ∈ [symbol] be the observed signal or data unit, such as an image. An energy-based model defines an unnormalized probability distribution of x as follows:

$${p}_{θ} ( x ) = \frac{1}{Z ( θ )} exp [ {f}_{θ} ( x ) ] , \qquad ( 1 )$$

where f_{θ}: [symbol] → [symbol] is the negative energy function and defined by a bottom-up neural network whose parameters are denoted by θ. The normalizing constant or partition function Z(θ)=∫exp[f_{θ}(x)]dx is analytically intractable and difficult to compute due to high dimensionality of x.

### b) Maximum Likelihood Learning Embodiments

Suppose unlabeled training examples {xᵢ, i=1, . . . n} from unknown data distribution p_{data}(x) are observed, the energy-based model in Eq. (1) may be trained from {xᵢ} by Markov chain Monte Carlo (MCMC)-based maximum likelihood estimation, in which MCMC samples are drawn from the model p_{θ}(x) to approximate the gradient of the log-likelihood function for updating the model parameters θ. Specifically, the log-likelihood may be given as

$$L ( θ ) = \frac{1}{n} {\sum }_{i = 1}^{n} log {p}_{θ} ( {x}_{i} ) .$$

For a large n, maximizing L(θ) is equivalent to minimizing the Kullback-Leibler (KL) divergence [symbol] _{KL}(p_{data}∥p_{θ}). The learning gradient may be given by:

$${L}^{′} ( θ ) = {𝔼}_{{p}_{data}} [ {∇}_{θ} {f}_{θ} ( x ) ] - {𝔼}_{{p}_{θ}} [ {∇}_{θ} {f}_{θ} ( x ) ] \approx \frac{1}{n} {\sum }_{i = 1}^{n} {∇}_{θ} {f}_{θ} ( {x}_{i} ) - \frac{1}{n} {\sum }_{i = 1}^{n} {∇}_{θ} {f}_{θ} ( {\tilde{x}}_{i} ) , \qquad ( 2 )$$

where the expectations may be approximated by averaging over the observed examples {xᵢ} and the synthesized examples {\tilde{x}ᵢ} generated from the current model p_{θ}(x), respectively.

### c) Langevin Dynamics Embodiments as MCMC

Generating synthesized examples from p_{θ}(x) may be accomplished with a gradient-based MCMC, such as Langevin dynamics, which may be applied as follows:

$${x}_{t} = {x}_{t - 1} + \frac{{δ}^{2}}{2} {∇}_{x} {f}_{θ} ( {x}_{t - 1} ) + {δ}_{{ε}_{t}} ; {x}_{0} ∼ {p}_{0} ( x ) , {ϵ}_{t} ∼ 𝒩 ( 0 , {I}_{D} ) , \qquad ( 3 )$$

$$t = 1 , … , T ,$$

where t indexes the Langevin time step, δ denotes the Langevin step size, ∈ₜ is a Brownian motion that explores different modes, p₀(x) is a uniform distribution that initializes MCMC chains, and I_{D} represents the identity matrix whose dimension is D.

### d) Langevin Flow Embodiments

As T→∞ and δ→0, x_{T} becomes an exact sample from p_{θ}(x) under some regularity conditions. However, it is impractical to run infinite steps with infinitesimal step size to generate fair examples from the target distribution. Additionally, convergence of MCMC chains in many cases may be hopeless because p_{θ}(x) can be very complex and highly multi-modal, then the gradient-based Langevin dynamics may have no way to escape from local modes, so that different MCMC chains with different starting points are unable to mix. Let \tilde{p}_{θ}(x) be the distribution of x_{T}, which is the resulting distribution of x after T steps of Langevin updates starting from x₀˜p₀(x). Due to the fixed p₀(x), T and δ the distribution \tilde{p}_{θ}(x) is well defined, which may be implicitly expressed by:

\tilde{p}_{θ}(x)=( [symbol] _{θ}p₀)(x)=∫p₀(z) [symbol] _{θ}(x|z)dz, (4)

where [symbol] _{θ} denotes the transition kernel of T steps of Langevin dynamics that samples p_{θ}. Generally, \tilde{p}_{θ}(x) is not necessarily equal to p_{θ}(x). \tilde{p}_{θ}(x) is dependent on T and δ, which are omitted in the notation for simplicity. The KL-divergence may be stated as [symbol] _{KL}(\tilde{p}_{θ}(x)∥p_{θ}(x))=−entropy(\tilde{p}_{θ}(x))− [symbol] _{\tilde{p}}_{_{θ}}₍ₓ₎[f(x)]+log Z. The gradient ascent part of Langevin dynamics, xₜ=xₜ₋₁+δ²/2∇ₓf_{θ}(xₜ₋₁), increases the negative energy f_{θ}(x) by moving x to the local modes of f_{θ}(x), and the diffusion part δ_{∈}_{ₜ} increases the entropy of \tilde{p}_{θ}(x) by jumping out of the local modes. According to the law of thermodynamics, [symbol] _{KL}(\tilde{p}_{θ}(x)∥p_{θ}(x)) decreases to zero monotonically as T→28 .

### 2. Normalizing Flow Embodiments

Let z∈ [symbol] be the latent vector of the same dimensionality as x. A normalizing flow may be of the form:

x=g_{α}(z); z˜q₀(z), (5)

where q₀(z) is a known prior distribution such as Gaussian white noise distribution [symbol] (0, I_{D}), and g_{α}: [symbol] → [symbol] is a mapping that comprises a sequence of L invertible transformations, i.e., g(z)=g_{L}○ . . . ○g ₂○g₁(z), whose inversion z=g_{α}⁻¹(x) and log-determinants of the Jacobians can be computed in closed form. α are the parameters of g_{α}. The mapping may be used to transform a random vector z that follows a simple distribution q₀ into a flexible distribution. Under the change-of-variables law, the resulting random vector x=g_{α}(z) has a probability density q_{α}(x)=q₀(g_{α}⁻¹(x))|det(∂g_{α}⁰⁻¹(x)/∂x)|. Let hₗ=gₗ(h₋₁). The successive transformations between x and z may be expressed as a flow z [symbol] h₁ [symbol] h₂. . . [symbol] x, where z:=h₀ and x:=h_{L} are defined for succinctness. Then, the determinant becomes |det(∂g_{α}⁻¹(x)/∂x)|=Πₗ₌₁^{L}|det(∂hₗ₋ₗ/∂hₗ)|. The log-likelihood of a datapoint x may be easily computed by:

$$log {q}_{α} ( x ) = log {q}_{0} ( z ) + {\sum }_{l = 1}^{L} log \vert det ( \frac{\partial {h}_{l - 1}}{\partial {h}_{l}} ) \vert . \qquad ( 6 )$$

With some smart designs of the sequence of transformations g ={g 1 , 1 =1, . , L}, the log-determinant in Eq. (6) can be easily computed, then the normalizing flow q a (x) may be

$$L ( α ) = \frac{1}{n} {\sum }_{i = 1}^{n} log {q}_{α} ( {x}_{i} )$$

trained by maximizing the exact data log-likelihood via grauient ascent methodology.

### D. CoopFlow Embodiments: Cooperative Training of Two Flows Embodiments

### 1. CoopFlow Method Embodiments

### a) Training Method Embodiments

Embodiments moved from trying to use a convergent Langevin dynamics to train a valid EBM. Instead, it is accepted that the short-run non-convergent MCMC is inevitable and more affordable in practice, and a non-convergent short-run Langevin flow is treated as a generator and embodiments jointly train it with a normalizing flow as a rapid initializer for more efficient generation. The resulting generator embodiments may be referred to (for convenience) as CoopFlow or CoopFlow embodiments, which comprise both a Langevin flow and a normalizing flow.

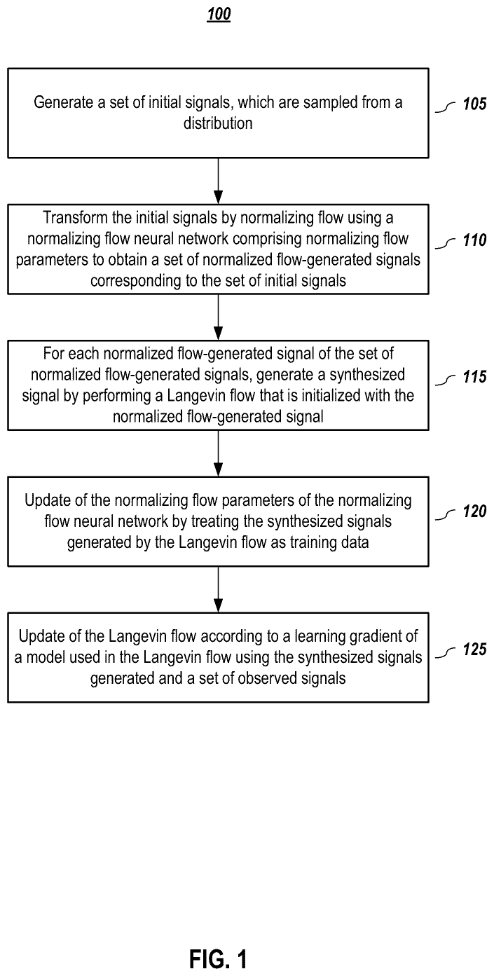

FIG. 1 depicts a CoopFlow methodology, according to embodiments of the present disclosure. In one or more embodiments, at each iteration, for i=1, . . . , m, a set of initial signals are generated zᵢ˜ [symbol] (0, I_{D}) (105), and then the signals zᵢ are transformed (110) by a normalizing flow using a normalizing flow neural network to obtain \hat{x}ᵢg_{α}(zᵢ), which represents a set of normalized flow-generated signals corresponding to the set of initial signals.

In one or more embodiments, starting from each normalized flow-generated signal \hat{x}ᵢ, a Langevin flow (i.e., a finite number of Langevin steps toward an EBM p_{θ}(x)) is performed (115) to obtain corresponding synthesized signals \tilde{x}ᵢ; that is, \tilde{x}ᵢ are considered synthesized examples that are generated by the CoopFlow model.

The parameters a of the normalizing flow neural network may be updated (120) by treating \tilde{X}ᵢ as training data, and the parameters θ of the Langevin flow may also be updated (125) according to the learning gradient of the EBM, which may be computed with the synthesized signal examples {\tilde{x}ᵢ} and the observed signal examples {xᵢ}.

Methodology 1 (below) presents a description of an embodiment of the CoopFlow methodology. An advantage of this training scheme is that methodologies for the MLE training of the EBM p_{θ} and the normalizing flow q_{α} can be readily adapted to implement training. The probability density of the CoopFlow π_{(θ,α)}(x) is well defined, which may be implicitly expressed by:

π_{(θ,α)}(x)=( [symbol] _{θ}q_{α})(x)=∫q_{α}(x′) [symbol] _{θ}(x|x′)dx′. (7)

[symbol] _{θ} is the transition kernel of the Langevin flow. If one increases the length T of the Langevin flow, π_{(θ,α)} will converge to the EBM p_{θ}(x). In one or more embodiments, the network f_{θ}(x) in the Langevin flow is scalar valued and is of freeform, whereas the network g_{α}(x) in the normalizing flow has high-dimensional output and is of a severely constrained form. Thus, the Langevin flow can potentially provide a tighter fit to p_{data}(x) than the normalizing flow. The Langevin flow may also be potentially more data efficient as it tends to have a smaller network than the normalizing flow. On the flip side, sampling from the Langevin flow may involve multiple iterations, whereas the normalizing flow may synthesize examples via a direct mapping. It is thus desirable, in one or more embodiments, to train these two flows simultaneously, where the normalizing flow serves as an approximate sampler to amortize the iterative sampling of the Langevin flow. Meanwhile, the normalizing flow is updated by a temporal difference MCMC teaching provided by the Langevin flow, to further amortize the short-run Langevin flow.

Methodology 1: CoopFlow Methodology Embodiment

| Input: | (1) Observed images {xᵢ}ᵢⁿ; |
|---|---|
| | (2) Number of Langevin steps T; |
| | (3) Langevin step size δ; |
| | (4) Learning rate η_{θ} for Langevin flow; |
| | (5) Learning rate η_{α} for normalizing flow; and |
| | (6) Batch size m. |
| Output: | Parameters {θ, α} |
| 1: | Randomly initialize θ and α. |
| 2: | repeat |

| | |
|---|---|
| 3: | Sample observed examples {xᵢ}ᵢ^{m}~p_{data}(x) |
| 4: | Sample noise examples {zᵢ}ᵢ₌₁^{m}~q₀(z) |
| 5: | Starting from zᵢ, generate \hat{x}ᵢ = g_{α}(zᵢ) via normalizing flow. |
| 6: | Starting from \hat{x}ᵢ, run a T-step Langevin flow to obtain \tilde{x}ᵢ by |
| | following Eq. (3) |
| 7: | $Given \{ {\tilde{x}}_{i} \} , update α by maximizing \frac{1}{m} {\sum }_{i = 1}^{m} log {q}_{α} ( {\tilde{x}}_{i} )$ |
| | with Eq. (6). |
| 8: | Given {xᵢ} and {\tilde{x}ᵢ}, update θ by following the gradient ∇θ |
| | in Eq (2). |

| | |
|---|---|
| 9: | until converged |

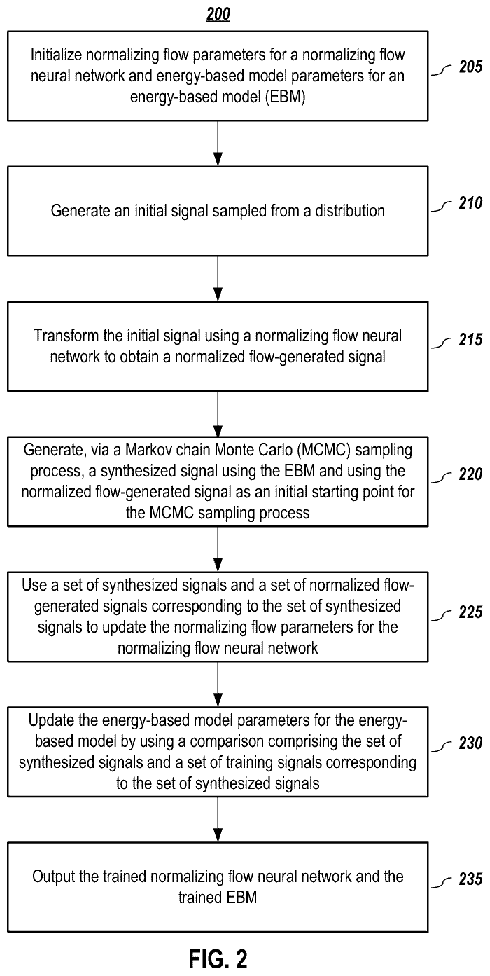

FIG. 2 depicts another CoopFlow methodology, according to embodiments of the present disclosure. In one or more embodiments, the normalizing flow parameters for a normalizing flow neural network and the energy-based model parameters for an energy-based model (EBM) are initialized (205).

A set of initial signals are obtained. An initial signal may be generated (210) by sampling from a distribution, such as a normal distribution.

For each initial signal of the set of initial signals, the initial signal is transformed (215) using a normalizing flow neural network to obtain a normalized flow-generated signal.

In one or more embodiments, a synthesized signal is generated (220), via a Markov chain Monte Carlo (MCMC) sampling process, using the EBM and using the normalized flow-generated signal as an initial starting point for the MCMC sampling process.

Given a set of synthesized signals and a set of normalized flow-generated signals corresponding to the set of synthesized signals, the normalizing flow parameters for the normalizing flow neural network may be updated (225).

In one or more embodiments, the energy-based model parameters for the EBM may be updated (230) by using a comparison comprising the set of synthesized signals and a set of training signals corresponding to the set of synthesized signals.

The steps 210-230 may be repeated until a stop condition has been reached. Any of a number of stop conditions may be used, including those previously mentioned and including but not limited to: an iteration number having been met, a processing time having been met, an amount of data processing having been met, a number of processing iterations having been met, or a convergence condition or conditions having been met.

Finally, in one or more embodiments, the final versions of the models (or their parameters) may be output. That is, in one or more embodiments, the trained energy-based model (or just its parameters) and the trained normalizing flow model (or just its parameters) may be output. The resulting combination of the models forms a CoopFlow generator.

### b) CoopFlow Generator Embodiments

As noted above, a final combination of the models forms a CoopFlow generator. In one or more embodiments, the CoopFlow generator may be used to synthesize a signal, such as an image or other type of data signal.

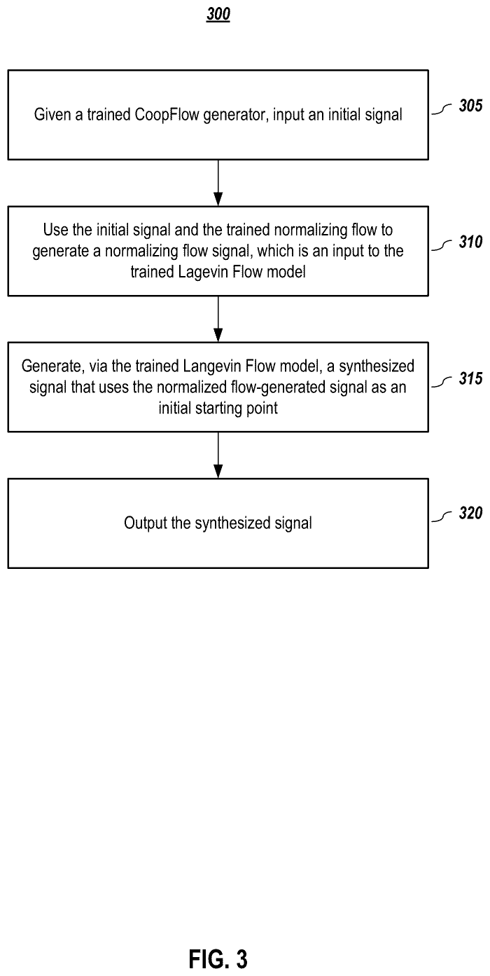

FIG. 3 depicts a methodology for using a trained CoopFlow model as a generator, according to embodiments of the present disclosure. Given a trained CoopFlow model, an initial signal is input (305). In one or more embodiments, the initial signal may be sampled from a distribution, may be a random input, may be a masked input, or may be a different type of input depending upon the ultimate generation task. Examples of different generation tasks are discussed in the Experiments section, below. The trained CoopFlow generator may then generate (310) an input signal for the trained Langevin Flow model by using the initial signal as an input to the trained normalizing flow, which produces the input signal for the trained Langevin Flow model. The trained Langevin Flow model uses the input signal produced by trained normalizing flow to generate (315) a synthesized signal. Once generated, the synthesized signal may be output (320).

Additional embodiments and usages are described below in the Experiments section.

### 2. Understanding the Learned Two Flows

### a) Convergence Equations

In the traditional contrastive divergence (CD) algorithm, MCMC chains are initialized with observed data so that the CD learning seeks to minimize [symbol] _{KL}(p_{data}(x)p_{θ}(x))− [symbol] _{KL}(( [symbol] _{θ}p_{data})(x)∥p_{θ}(x)), where ( [symbol] _{θ}p_{data})(x) denotes the marginal distribution obtained by running the Markov transition [symbol] _{θ}, which is specified by the Langevin flow, from the data distribution p_{data}. In a CoopFlow methodology embodiment, the learning of the EBM (or the Langevin flow model) follows a modified contrastive divergence, where the initial distribution of the Langevin flow is modified to be a normalizing flow q_{α}. Thus, at iteration t, the update of θ follows the gradient of [symbol] _{KL}(p_{data}∥p_{θ})− [symbol] _{KL}( [symbol] _{θ}_{^{(t)}}q_{α}_{^{(t)}}∥p_{θ}) with respect to θ. Compared to the traditional CD loss, the modified one replaces p_{data} by q_{α} in the second KL divergence term. At iteration t, the update of the normalizing flow q_{α} follows the gradient of [symbol] _{KL}( [symbol] _{θ}_{^{(t)}}q_{α}_{^{(t)}}∥q_{α}) with respect to α. Let (θ*, α*) be a fixed point the learning method converges to, then one has the following convergence equations:

$${θ}^{*} = arg {min}_{θ} {𝔻}_{KL} ( {p}_{data} \vert \vert {p}_{θ} ) - {𝔻}_{KL} ( {𝒦}_{{θ}^{*}} {q}_{{α}^{*}} \vert \vert {p}_{θ} ) , \qquad ( 8 )$$

$${α}^{*} = arg {min}_{α} {𝔻}_{KL} ( {𝒦}_{{θ}^{*}} {q}_{{α}^{*}} \vert \vert {q}_{α} ) . \qquad ( 9 )$$

### b) Ideal Case Analysis

In the idealized scenario where the normalizing flow q_{α} has infinite capacity and the Langevin sampling can mix and converge to the sampled EBM, Eq. (9) means that q_{α}_{^{*}} attempts to be the stationary distribution of [symbol] _{θ*} which is p_{θ*} because [symbol] _{θ*} is the Markov transition kernel of a convergent MCMC sampled from p_{θ*}. That is, min_{α} [symbol] _{KL}( [symbol] _{θ*}q_{α*}∥q_{α})=0, thus q_{α*}=p_{θ*}. With the second term becoming 0 and vanishing, Eq. (8) degrades to min_{θ} [symbol] _{KL}(p_{data}∥p_{θ}) and thus θ^{*} is the maximum likelihood estimate. On the other hand, the normalizing flow q_{α} chases the EBM p_{θ} toward p_{data}, thus α^{*} is also a maximum likelihood estimate.

### c) Moment Matching Estimator

In the practical scenario where the Langevin sampling is not mixing, a CoopFlow model πₜ= [symbol] _{θ}_{^{(t)}}q_{α}_{^{(t)}} is an interpolation between the learned q_{α} (t) and p o w, and it converges to IT * =5C 0 *q_{α} *, which is an interpolation between q_{α}_{^{(t)}} and p_{θ}_{^{(t)}}. π^{*} is the short-run Langevin flow starting from q_{α*} towards EBM p_{θ*}. π^{*} is a legitimate generator because [symbol] [∇_{θ}f_{θ*}(x)]= [symbol] [∇_{θ}f_{θ*}(x)] at convergence. That is, π^{*} leads to moment matching in the feature statistics ∇_{θ}f_{θ*}(x). In other words, π^{*} satisfies the above estimating equation.

### d) Understanding Via Information Geometry

Consider a simple EBM with f_{θ}(x)= [symbol] θ, h(x) [symbol] , where h(x) is the feature statistics. Since ∇_{θ}f_{θ}(x)=h(x), the MLE of the EBM p_{θ}_{_{MLE}} is a moment matching estimator due to

$${𝔼}_{{p}_{data}} [ h ( x ) ] = {𝔼}_{{p}_{{θ}_{MLE}}} [ h ( x ) ] .$$

The CoopFlow π^{*} also converges to a moment matching estimator, i.e., [symbol] [h(x)]= [symbol] [h(x)].

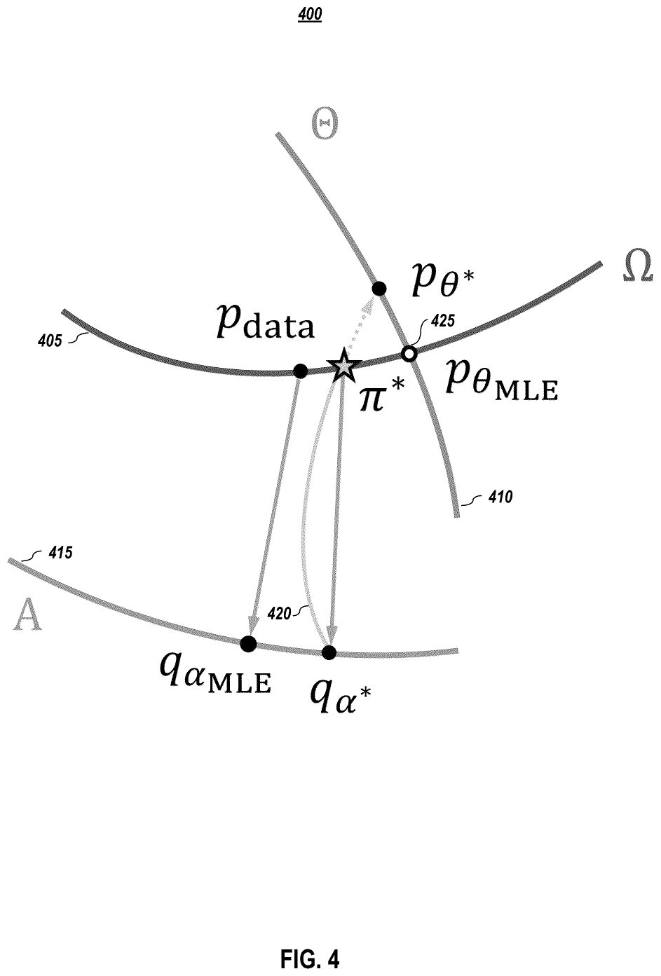

FIG. 4 depicts an illustration of model distributions that correspond to different parameters at convergence, according to embodiments of the present disclosure. Three families of distributions are first introduced: Ω={p: [symbol] ₚ[h(x)]= [symbol] [h(x)]},

$$Θ = \{ {p}_{θ} ( x ) = \frac{exp ( 〈 θ , h ( x ) 〉 )}{Z ( θ )} , ∀ θ \} ,$$

and A={q_{α}, ∀α}, which are shown by curves 405, 410, and 415, respectively, in FIG. 4.

Ω is the set of distributions that reproduce statistical property h(x) of the data distribution. Obviously, p_{θ}_{_{MLE}}, p_{data}, and π^{*}= [symbol] _{θ*}q_{α*} are included in Ω. Θ is the set of EBMs with different values of θ, thus p_{θ}_{_{MLE}} and p_{θ*} belong to Θ. Because of the short-run Langevin flow, p_{θ*} is not a valid model that matches the data distribution in terms of h(x), and thus p_{θ*} is not in Ω. A is the set of normalizing flow models with different values of α, thus p_{θ*} and q_{α}_{_{MLE}} belong to A. The line 420 shows the MCMC trajectory. The solid segment of the line 420, starting from p_{θ*} to [symbol] _{θ*}p_{θ*}, illustrates the short-run non-mixing MCMC that is initialized by the normalizing flow p_{θ*} in A and arrives at π^{*}= [symbol] _{θ*}p_{θ*} in Ω. The dotted segment of the line 420, starting from π^{*}= [symbol] _{θ*}p_{θ*} in Ω to p_{θ*} in Θ, shows the potential long-run MCMC trajectory, which is not really realized because of stopping short in MCMC. If the number of steps of short-run Langevin flow were increased, [symbol] _{KL}(π^{*}∥p_{θ*}) will be monotonically decreasing to 0. Though π^{*} stops midway in the path toward p_{θ*}, π^{*} is still a valid generator because it is in Ω.

e) Perturbation of MLE

p_{θ}_{_{MLE}} is the intersection between Θ and Ω. It is the projection of p_{data} onto Θ because θ_{MLE}=arg min_{θ} [symbol] _{KL}(p_{data}∥p_{θ}). q_{α}_{_{MLE}} is also a projection of p_{data} onto A because α_{MLE}=arg min_{α} [symbol] _{KL}(p_{data}∥q_{α}). Generally, q_{α}_{_{MLE}} is far from p_{data} due to its restricted form network, whereas p_{θ}_{_{MLE}} is very close to p_{data} due to its scalar-valued freeform network. Because the short-run MCMC is not mixing, θ^{*}≠θ_{MLE} and α^{*}≠α_{MLE}. θ^{*} and α^{*} are perturbations of θ_{MLE} and α_{MLE}, respectively. p_{θ}_{_{MLE}} shown by an empty dot 425 is not attainable unfortunately. It should be noted that, as T goes to infinity, p_{θ*}=p_{θ}_{_{MLE}}, and q_{α*}=q_{α}_{_{MLE}}. Note that Ω, Θ, and A are high-dimensional manifolds instead of 1D curves as depicted in FIGS. 4, and π^{*} may be farther away from p_{data} than p_{θ}_{_{MLE}} is. During learning, q_{α}_{^{(t+1)}} is the projection of [symbol] _{θ}_{^{(t)}}q_{α}_{^{(t)}} on A. At convergence, q_{α*} is the projection of π^{*}= [symbol] _{θ*}q_{α*} on A. There is an infinite looping between q_{α*} and π^{*}= [symbol] _{θ*}q_{α*} at convergence of a CoopFlow methodology, i.e., π^{*} lifts q_{α*} off the ground A, and the projection drops π^{*} back to q_{α*}. Although p_{θ*} and q_{α*} are biased, they are not wrong. Many useful models and methods, e.g., variational autoencoder and contrastive divergence are also biased to MLE. Their learning objectives also follow perturbation of MLE.

### E. Experiments

In this section, some experiment results on various tasks are showcased. It shall be noted that these experiments and results are provided by way of illustration and were performed under specific conditions using a specific embodiment or embodiments; accordingly, neither these experiments nor their results shall be used to limit the scope of the disclosure of the current patent document.

First presented is a relatively simple example, a toy example, to illustrate the basic idea of a CoopFlow embodiment in Section E.1. Image generation results are discussed in Section E.2. Section E.3 demonstrates a learned CoopFlow is useful for image reconstruction and inpainting, while Section E.4 shows that the learned latent space is meaningful so that it can be used for interpolation.

### 1. Toy Sample Study

The CoopFlow concept is demonstrate herein using a two-dimensional toy example where data lie on a spiral. Three CoopFlow models were trained with different lengths of Langevin flows.

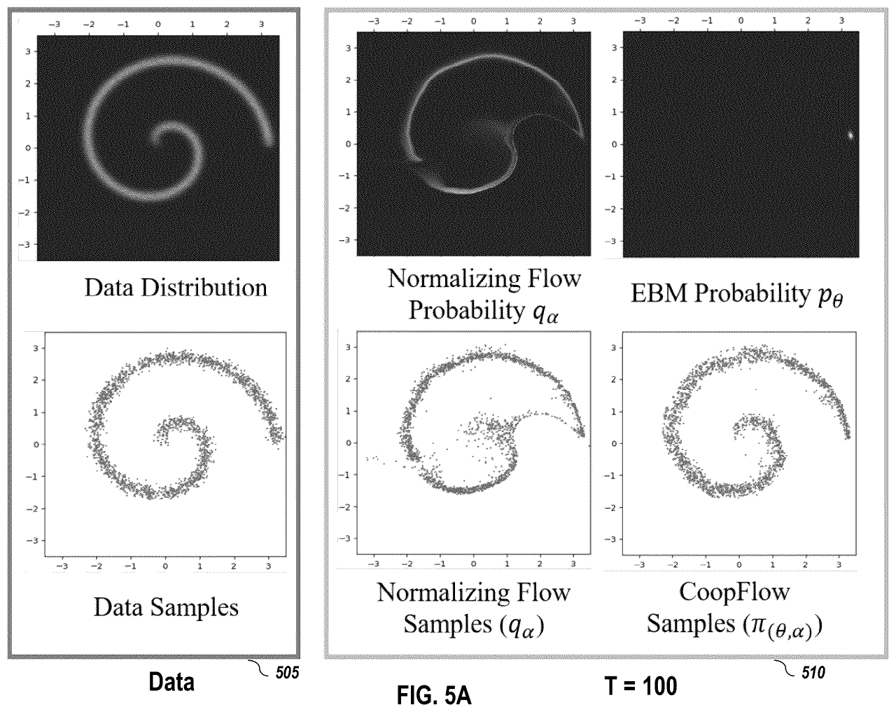

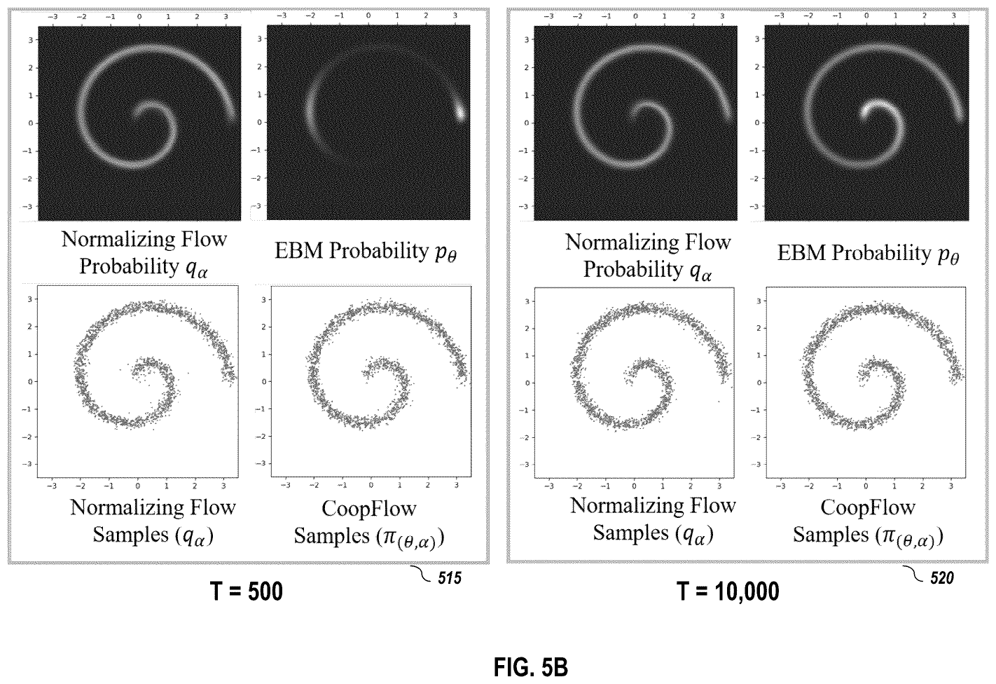

FIGS. 5A & 5B depicts learning CoopFlows on two-dimensional data, according to embodiments of the present disclosure. The ground truth data distribution is shown in the 505 in FIG. 5A, and the models trained with different Langevin steps are in the other boxes (510, 515, and 520). In each of the boxes (510, 515, and 520), the first row shows the learned distributions of the normalizing flow and the EBM, and the second row shows the samples from the learned normalizing flow and the learned CoopFlow embodiment.

As shown in FIG. 5B, the rightmost box 520 shows the results obtained with 10,000 Langevin steps. It can be seen that both the normalizing flow q_{α} and the EBM p_{θ} can fit the ground truth density, which is displayed in the box 505 in FIG. 5A, perfectly. This validates that, with a sufficiently long Langevin flow, the CoopFlow methodology can learn both a valid q_{α} and a valid p_{θ}. The box 510 in FIG. 5A represents the model trained with 100 Langevin steps. This is a typical non-convergent short-run MCMC setting. In this case, neither q_{α} nor p_{θ} is valid, but their cooperation is. The short-run Langevin dynamics toward the EBM actually works as a flow-like generator that modifies the initial proposal by the normalizing flow. It can be seen that the samples from q_{α} are not perfect, but after the modification, the samples from π_{(θ,α)} fit the ground truth distribution very well. The box 515 in FIG. 5B shows the results obtained with 500 Langevin steps. This is still a short-run setting, even though it uses more Langevin steps. p_{θ} becomes better than that with 100 steps, but it is still invalid. With an increased number of Langevin steps, samples from both q_{α} and π_{(θ,α)} are improved and comparable to those in the long-run setting with 10,000 steps. The results verify that a CoopFlow embodiment might learn a biased EBM and a biased normalizing flow if the Langevin flow is non-convergent; however, the non-convergent Langevin flow together with the biased normalizing flow can still form a valid generator that synthesizes valid examples.

### 2. Image Generation Embodiments

A CoopFlow model embodiment was tested on three image datasets for image synthesis. (i) Dataset 1 was a dataset containing ˜50k training images and ˜10k testing images in 10 classes; (ii) Dataset 2 was a dataset containing over 70k training images and over 20k testing images of numbers; (iii) Dataset 3 was a facial dataset containing over 200k images. All images were downsampled to the resolution of 32×32. For the tested model embodiment, the results are shown of three different settings. CoopFlow(T=30) denotes the setting where a normalizing flow and a Langevin flow were trained together from scratch and 30 Langevin steps were used. CoopFlow(T=200) denotes the setting where the number of Langevin steps was increased to 200. In the CoopFlow(Pre) setting, a normalizing flow was first pretrained from observed data, and then the CoopFlow was trained with the parameters of the normalizing flow being initialized by the pretrained one. A 30-step Langevin flow was used in this setting. For all the three settings, the Langevin step size was slightly increased at the testing stage for better performance. Quantitative results are in Table 1

TABLE 1
FID scores on three datasets (32 × 32 pixels). Please note
that full citations for the cited documents in paratheses in
the table are provided in the Appendix at Section G.13, below)

| | | Models | FID↓ |
|---|---|---|---|
| Dataset 1 | VAE | VAE (Kingma & Welling, 2014) | 78.41 |
| | Autoregres- | PixelCNN (Salimans et al., 2017) | 65.93 |
| | sive | PixelIQN (Ostrovski et al., 2018) | 49.46 |
| | GAN | WGAN-GP(Gulrajani et al., 2017) | 36.40 |
| | | SN-GAN (Miyato et al., 2018) | 21.70 |
| | | StyleGAN2-ADA (Karras et al., 2020) | 2.92 |
| | Score- | NCSN (Song & Ermon, 2019) | 25.32 |
| | Based | NCSN-v2 (Song & Ermon, 2020) | 31.75 |
| | | NCSN++ (Song et al., 2021) | 2.20 |
| | Flow | Glow (Kingma & Dhariwal, 2018) | 45.99 |
| | | Residual Flow (Chen et al., 2019) | 46.37 |
| | EBM | LP-EBM (Pang et al., 2020) | 70.15 |
| | | EBM-SR (Nijkamp et al., 2019) | 44.50 |
| | | EBM-IG (Du & Mordatch, 2019) | 38.20 |
| | | CoopVAEBM (Xie et al., 2021b) | 36.20 |
| | | CoopNets (Xie et al., 2020a) | 33.61 |
| | | Divergence Triangle (Han et al., 2020) | 30.10 |
| | | VARA (Grathwohl et al., 2021) | 27.50 |
| | | EBM-CD (Du et al., 2021) | 25.10 |
| | | GEBM (Arbel et al., 2021) | 19.31 |
| | | CF-EBM (Zhao et al. (2021) | 16.71 |
| | | VAEBM (Xiao et al., 2021) | 12.16 |
| | | EBM-Diffusion (Gao et al., 2021) | 9.60 |
| | Flow + | NT-EBM (Nijkamp et al., 2020a) | 78.12 |
| | EBM | EBM-FCE (Gao et al., 2020) | 37.30 |
| | Embodi- | CoopFlow(T = 30) | 21.16 |
| | ments | CoopFlow(T = 200) | 18.89 |
| | | CoopFlow(Pre) | 15.80 |

| | Models | FID↓ |
|---|---|---|
| Dataset 2 | ABP (Han et al., 2017) | 49.71 |
| | ABP-SRI (Nijkamp et al., 2020b) | 35.23 |
| | ABP-OT (An et al., 2021) | 19.48 |
| | VAE (Kingma & Welling, 2014) | 46.78 |
| | 2sVAE (Dai & Wipf, 2019) | 42.81 |
| | RAE (Ghosh et al., 2020) | 40.02 |
| | Glow (Kingma & Dhariwal, 2018) | 41.70 |
| | DCGAN (Radford et al., 2016) | 21.40 |
| | NT-EBM (Nijkamp et al., 2020a) | 48.01 |
| | LP-EBM (Pang et al., 2020) | 29.44 |
| | EBM-FCE (Gao et al., 2020) | 20.19 |
| | CoopFlow(T = 30) Embodiment | 18.11 |
| | CoopFlow(T = 200) Embodiment | 16.97 |
| | CoopFlow(Pre) Embodiment | 15.32 |
| Dataset 3 | ABP (Han et al., 2017) | 51.50 |
| | ABP-SRI (Nijkamp et al., 2020b) | 36.84 |
| | VAE (Kingma & Welling, 2014) | 38.76 |
| | Glow (Kingma & Dhariwal, 2018) | 23.32 |
| | DCGAN (Radford et al., 2016) | 12.50 |
| | EBM-FCE (Gao et al., 2020) | 12.21 |
| | GEBM (Arbel et al., 2021) | 5.21 |
| | CoopFlow(T = 30) Embodiment | 6.44 |
| | CoopFlow(T = 200) Embodiment | 4.90 |
| | CoopFlow(Pre) Embodiment | 4.15 |

To calculate FID (Fréchet Inception Distance) scores, 50,000 samples were generated on each dataset. The tested model embodiments outperformed most of the baseline methods. Lower FID scores were obtained compared to the individual normalizing flows and prior works that jointly train a normalizing flow with an EBM. Embodiments also achieved comparable results with the state-of-the-art EBMs. It can be observed that using more Langevin steps or a pretrained normalizing flow may help improve the performance of a CoopFlow embodiment. The former enhances the expressive power, while the latter stabilizes the training. More experimental details and results can be found in Appendix.

### 3. Image Reconstruction and Inpainting Embodiments

In this section, it is shown that a learned CoopFlow model embodiment is able to reconstruct observed images. A CoopFlow model π_{(θ,α)}(x) may be considered a latent variable generative model: z˜q₀(z); \hat{x}=g_{α}(z); x=F_{θ}(\hat{x}, e), where z denotes the latent variables, e denotes all the injected noises in the Langevin flow, and F_{θ} denotes the mapping realized by a T-step Langevin flow that is actually a T-layer noise-injected residual network. Since the Langevin flow is not mixing, x is dependent on \hat{x} in the Langevin flow, thus also dependent on z. The CoopFlow model embodiment is a generator x=F_{θ}(g_{α}(z), e), so one can reconstruct any x by inferring the corresponding latent variables z using gradient descent on L (z)=∥x−F_{θ}(g_{α}(z), e)∥², with z being initialized by q₀. However, g is an invertible transformation, so z may be inferred by an efficient way, i.e., first finding \hat{x} by gradient descent on L(\hat{x})=∥x−F_{θ}(\hat{x}, e)∥², with \hat{x} being initialized by \hat{x}₀=g_{α}(z) where z˜q₀(z) and e being set to be 0, and then use z=g_{α}⁻¹(\hat{x}) to get the latent variables. These two methods are equivalent, but the latter one is computationally efficient, since computing the gradient on the whole two-flow generator F_{θ}(g_{α}(z), e) is difficult and time-consuming. Let \hat{x}^{*}=arg min _{\hat{x}}: L(\hat{x}). The reconstruction may be given by F_{θ}(\hat{x}^{*}). The optimization was performed using 200 steps of gradient descent over \hat{x}.

In reconstruction results, the tested model embodiment successfully reconstructed the observed images, verifying that a CoopFlow embodiment with a non-mixing MCMC is indeed a valid latent variable model.

It is further shown that a tested model embodiment was also capable of doing image inpainting. Similar to image reconstruction, given a masked observation xₘₐₛₖ along with a binary matrix M indicating the positions of the unmasked pixels, \hat{x} may be optimized to minimize the reconstruction error between F_{θ}(\hat{x}) and xₘₐₛₖ in the unmasked area, i.e., L(\hat{x})=∥M ⊙(xₘₐₛₖ−F_{θ}(\hat{x}))∥², where ⊙ is the element-wise multiplication operator. \hat{x} is still initialized by the normalizing flow. In experience, it was seen that the tested model embodiment reconstructed the unmasked areas faithfully and simultaneously filled in the blank areas of the input images. With different initializations, embodiments can inpaint diversified and meaningful patterns.

### 4. Interpolation in the Latent Space

CoopFlow model embodiments are capable of doing interpolation in the latent space z. Given an image x, its corresponding \hat{x}^{*} is found using the reconstruction method described in Section E.3, above. z may then be inferred by the inversion of the normalizing flow z^{*}=g_{α}⁻¹(\hat{x}^{*}). Experiments of interpolation between two latent vectors inferred from observed images were performed. For each example experiment, two observed images were at the ends. Each image in between was obtained by first interpolating the latent vectors of the two end images, and then generating the image using a CoopFlow generator embodiments. This experiment shows that a CoopFlow generator embodiment can learn a smooth latent space that traces the data manifold.

### F. Some Conclusion/Observations

Embodiments in this patent document address an interesting problem of learning two types of deep flow models in the context of energy-based framework for signal representation and generation. In one or more embodiments, one model is a normalizing flow that generates synthesized examples by transforming Gaussian noise examples through a sequence of invertible transformations, while the other model is the Langevin flow that generates synthesized examples by running a non-mixing, non-convergent short-run MCMC toward an EBM. Also presented herein were embodiments of CoopFlow methodologies to train the short-run Langevin flow model jointly with the normalizing flow serving as a rapid initializer in a cooperative manner. The experiments showed that the CoopFlow embodiments are valid generative models that can be useful for various tasks, including but not limited to signal generation, reconstruction, and interpolation, such as image generation, image reconstruction, and image interpolation.

### G. Appendix

### 1. Network Architecture of CoopFlow Embodiments

For all the experiments, the same network architecture was used. For the normalizing flow g_{α}(z) in the CoopFlow framework embodiment, the Flow++ network architecture was used. As to the EBM in the CoopFlow embodiment, the architecture shown in Table 2 was used to design the negative energy function f_{θ}(x).

TABLE 2
Network architecture of the EBM in the CoopFlow embodiment
(str: stride, pad: padding, and ch: channel).

EBM Architecture
3 × 3 Conv2d, str = 1, pad = 1, ch = 128; Swish
Residual Block, ch = 256
Residual Block, ch = 512
Residual Block, ch = 1,024
3 × 3 Conv2d, str = 4, pad = 0, ch = 100; Swish
Sum over channel dimension
Residual Block Architecture
3 × 3 Conv2d, str = 1, pad = 1; Swish
3 × 3 Conv2d, str = 1, pad = 1; Swish
+3 × 3 Conv2d, str = 1, pad = 1; Swish (input)
2 × 2 Average Pooling

### 2. Experimental Details

There were three different settings for the CoopFlow model embodiments in the experiments. In the CoopFlow(T=30) setting and the CoopFlow(T=200) setting, both the normalizing flow and the Langevin flow were trained from scratch. The difference between them were the number of the Langevin steps. The CoopFlow(T=200) used a longer Langevin flow than the CoopFlow(T=30). Following Ho et al. (2019) (Jonathan Ho, Xi Chen, Aravind Srinivas, Yan Duan, and Pieter Abbeel. Flow++: Improving flow-based generative models with variational dequantization and architecture design. In Proceedings of the 36th International Conference on Machine Learning (ICML), pp. 2722-2730, Long Beach, CA, 2019, which is incorporated by reference herein in its entirety) and use the data-dependent parameter initialization method (e.g., Tim Salimans and Diederik P. Kingma. Weight normalization: A simple reparameterization to accelerate training of deep neural networks. In Advances in Neural Information Processing Systems 29 (NIPS), pp. 901, Barcelona, Spain, 2016, which is incorporated by reference herein in its entirety) for the normalizing flow in both settings CoopFlow(T=30) and CoopFlow(T=200). On the other hand, as to the CoopFlow(Pre) setting, a normalizing flow was first pretrained on training examples, and a 30-step Langevin flow was trained, whose parameters were initialized randomly, together with the pretrained normalizing flow by following Methodology 1, above. The cooperation between the pretrained normalizing flow and the untrained Langevin flow may be difficult and unstable because the Langevin flow is not knowledgeable at all to teach the normalizing flow. To stabilize the cooperative training and make a smooth transition for the normalizing flow, a warm-up phase was included in the CoopFlow methodology. During this phase, instead of updating both the normalizing flow and the Langevin flow, the parameters of the pretrained normalizing flow were fixed and only the parameters of the Langevin flow were updated. After a certain number of learning epochs, the Langevin flow may get used to the normalizing flow initialization and learn to cooperate with it. Then, both two flows begin to be updated as described in Methodology 1. This strategy is effective in preventing the Langevin flow from generating bad synthesized examples at the beginning of the CoopFlow methodology to ruin the pretrained normalizing flow.

The Adam optimizer was used for training. Learning rates were set at η_{α}=0.0001 and η_{θ}=0.0001 for the normalizing flow and the Langevin flow, respectively. β₁=0.9 and β₂=0.999 were used for the normalizing flow, and β₁=0.5 and β₂=0.5 were used for the Langevin flow. In the Adam optimizer, β₁ is the exponential decay rate for the first moment estimates, and β₂ is the exponential decay rate for the second-moment estimates. A random horizontal flip was adopted as data augmentation only for Dataset 1. The noise term was removed in each Langevin update by following Zhao et al. (Yang Zhao, Jianwen Xie, and Ping Li. Learning energy-based generative models via coarse-to-fine expanding and sampling. In Proceeding of the 9th International Conference on Learning Representations (ICLR), Virtual Event, 2021, which is incorporated by reference herein in its entirety). An alternative strategy to gradually decay the effect of the noise term is also presented in Section G.10, below. The batch sizes for settings CoopFlow(T=30), CoopFlow(T=200), and CoopFlow(Pre) were 28, 32, and 28, respectively. The values of other hyperparameters can be found in Table 3.

TABLE 3
Hyperparameter setting of the CoopFlow embodiments in the experiments.

| | | # of epochs | # of epochs | | | Langevin | Langevin |
|---|---|---|---|---|---|---|---|
| | | to pretrain | to pretrain | # of epochs | # of | step | step |
| | | Normalizing | Langevin | for | Langevin | size | size |
| Model | Dataset | Flow | Flow | CoopFlow | Flow | (train) | (test) |
| CoopFlow | Dataset 1 | 0 | 0 | 100 | 30 | 0.03 | 0.04 |
| (T = 30) | Dataset 2 | 0 | 0 | 100 | 30 | 0.03 | 0.035 |
| | Dataset 3 | 0 | 0 | 100 | 30 | 0.03 | 0.035 |
| CoopFlow | Dataset 1 | 0 | 0 | 100 | 200 | 0.01 | 0.012 |
| (T = 200) | Dataset 2 | 0 | 0 | 100 | 200 | 0.011 | 0.0125 |
| | Dataset 3 | 0 | 0 | 100 | 200 | 0.011 | 0.013 |
| CoopFlow | Dataset 1 | 300 | 25 | 75 | 30 | 0.03 | 0.04 |
| (Pre) | Dataset 2 | 200 | 10 | 90 | 30 | 0.03 | 0.035 |
| | Dataset 3 | 80 | 10 | 90 | 30 | 0.03 | 0.035 |

### 3. Analysis of Hyperparameters of Langevin Flow

The influence of the Langevin step size δ and the number of Langevin steps T on a dataset was investigated using the CoopFlow(Pre) setting. The Langevin step size was first set to be 0.03 and the number of Langevin steps were varied from 10 to 50. The results are shown in Table 4. On the other hand, the influence of the Langevin step size is shown in Table 5, where the number of Langevin steps were fixed to be 30 and the Langevin step size used in training were varied. When synthesizing examples from the learned models in testing, the Langevin step size was slightly increased by a ratio of 4/3 for better performance. It can be seen that the choices of 30 as the number of Langevin steps and 0.03 as the Langevin step size were reasonable. Increasing the number of Langevin steps may improve the performance in terms of FID, but also be computationally expensive. The choice of T=30 is a trade-off between the synthesis performance and the computation efficiency.

TABLE 4
FID scores over the numbers of Langevin
steps of CoopFlow(Pre) on Dataset 1.

| # of Langevin steps | 10 | 20 | 30 | 40 | 50 |
|---|---|---|---|---|---|
| FID ↓ | 16.46 | 15.20 | 15.80 | 16.80 | 15.64 |

TABLE 5
FID scores of CoopFlow(Pre) on Dataset
1 under different Langevin step sizes.

| | | | | | | |
|---|---|---|---|---|---|---|
| Langevin step | 0.01 | 0.02 | 0.03 | 0.04 | 0.05 | 0.10 |
| size (train) | | | | | | |
| Langevin step | 0.013 | 0.026 | 0.04 | 0.053 | 0.067 | 0.13 |
| size (test) | | | | | | |
| FID ↓ | 15.99 | 16.32 | 15.80 | 16.52 | 18.17 | 19.82 |

### 4. Ablation Study

To show the effect of the cooperative training, a CoopFlow model embodiment was compared with an individual normalizing flow and an individual Langevin flow. For fair comparison, the normalizing flow component in the CoopFlow embodiment has the same network architecture as that in the individual normalizing flow, while the Langevin flow component in the CoopFlow embodiment also used the same network architecture as that in the individual Langevin flow. The individual normalizing flow was trained by following Ho et al. (2019) (Jonathan Ho, Xi Chen, Aravind Srinivas, Yan Duan, and Pieter Abbeel. Flow++: Improving flow-based generative models with variational dequantization and architecture design. In Proceedings of the 36th International Conference on Machine Learning (ICML), pp. 2722-2730, Long Beach, CA, 2019, which is incorporated by reference herein in its entirety), and the individual Langevin flow was trained by following Nijkamp et al. (Erik Nijkamp, Mitch Hill, Song-Chun Zhu, and Ying Nian Wu. Learning non-convergent nonpersistent short-run MCMC toward energy-based model. In Advances in Neural Information Processing (NeurIPS), pp. 5233-5243, Vancouver, Canada, 2019, which is incorporated by reference herein in its entirety). All three models were trained on Dataset 1. A comparison of these three models in terms of FID is presented in Table 6. From Table 6, it can be seen that the CoopFlow model embodiment outperformed both the normalizing flow and the Langevin flow by a large margin, which verifies the effectiveness of the proposed CoopFlow methodology.

TABLE 6
A FID comparison among the normalizing flow, the
Langevin flow, and the CoopFlow embodiment.

| Model | Normalizing Flow | Langevin Flow | CoopFlow Embodiment |
|---|---|---|---|
| FID ↓ | 92.10 | 49.51 | 21.16 |

### 5. More Image Generation Results

By comparing synthesized images generated by CoopFlow models and those generated by the normalizing flow components in the CoopFlow models, it was observed that there is an obvious visual gap between the normalizing flow and the CoopFlow. The samples from the normalizing flow look blurred but become sharp and clear after the Langevin flow revision. This supports claims made in Section D.2.

### 6. FID Curve Over Training Epochs

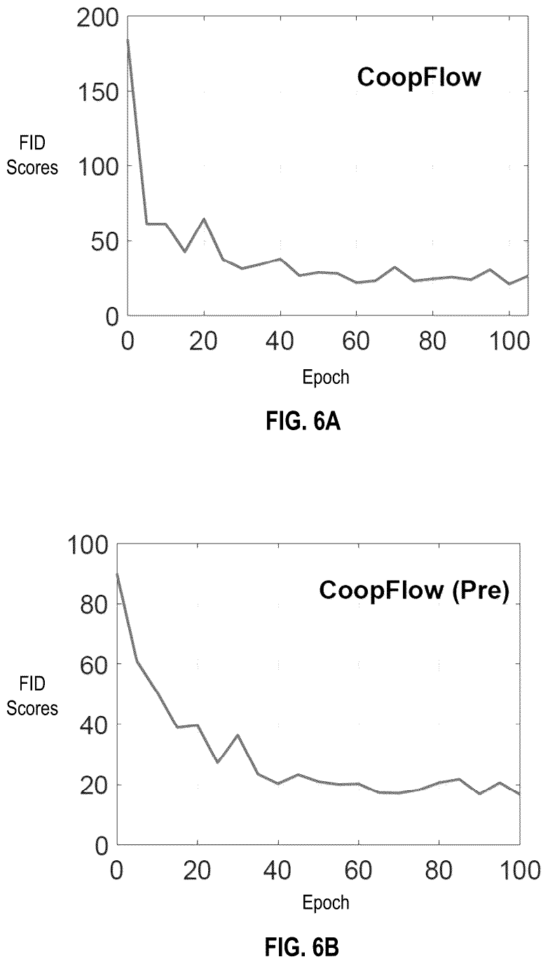

FIGS. 6A and 6B show the FID trends during the training of CoopFlow model embodiments on a dataset. FIG. 6A depicts the FID curve for a CoopFlow(T=30) model embodiment, and FIG. 6B depicts the FID curve for a CoopFlow(Pre) model embodiment. Each curve represents the FID scores over training epochs. The CoopFlow model embodiments were trained using the settings of CoopFlow(T=30) and CoopFlow(Pre). For each of them, it was observed that, as the cooperative learning proceeded, the FID kept decreasing and converged to a low value. This is empirical evidence to show that the proposed CoopFlow methodology is a convergent algorithm.

### 7. Quantitative Results for Image Reconstruction

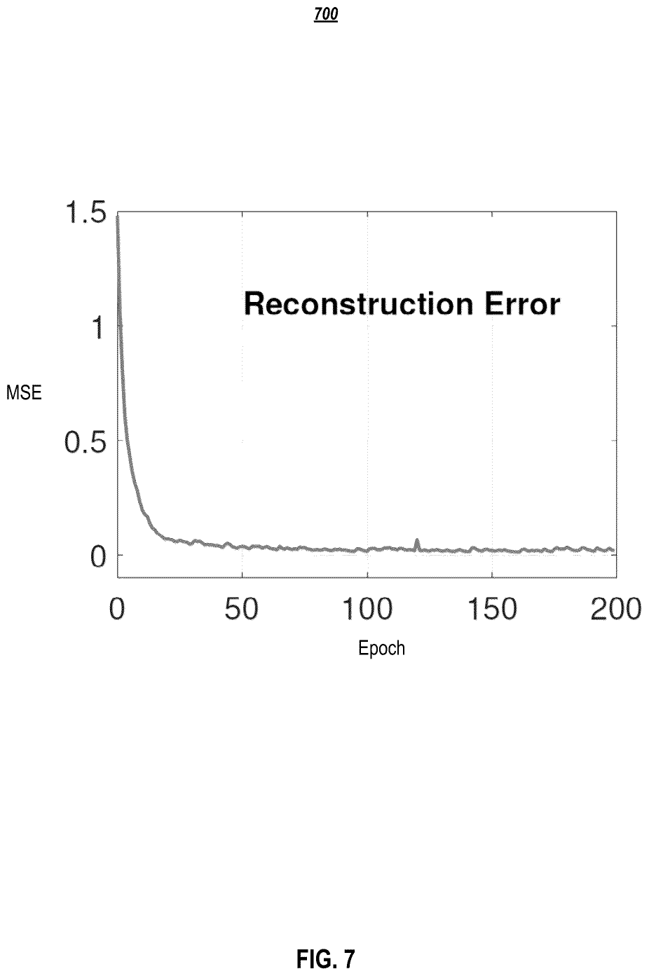

Provided herein are additional quantitative results for the image reconstruction experiment in Section E.3. Following Nijkamp et al. (2019) (cited above), the per-pixel mean squared error (MSE) was calculated on 1,000 examples in the testing set of a dataset. A 200-step gradient descent was used to minimize the reconstruction loss. The reconstruction error curve showing the MSEs over iterations is in FIG. 7, and the final per-pixel MSE is reported in Table 7. For a baseline, an EBM was trained using a 100-step short-run MCMC and the resulting model was the short-run Langevin flow. Then, it is applied to the reconstruction task of the same 1,000 images by following Nijkamp et al (2019). The baseline EBM had the same network architecture as that of the EBM component in the CoopFlow model embodiment for fair comparison. The experiment results show that the CoopFlow embodiment works better than the individual short-run Langevin flow in this image reconstruction task.

TABLE 7
Reconstruction error (MSE per pixel).

| Model | MSE |
|---|---|
| Langevin Flow/EBM with short-run MCMC | 0.1083 |
| CoopFlow Embodiment | 0.0254 |

### 8. Model Complexity

In Table 8, a comparison of different models in terms of model size and FID score are presented. Here, those models that have a normalizing flow component, e.g., EBM-FCE, NT-EBM, GLOW, Flow++, as well as an EBM jointly trained with a VAE generator, e.g., VAEBM, were mainly compared. It was seen that the CoopFlow model embodiments have a good balance between model complexity and performance. It is noteworthy that both the CoopFlow embodiment and the EBM-FCE comprise an EBM and a normalizing flow, and their model sizes are also similar, but the CoopFlow model embodiments achieve a much lower FID than the EBM-FCE. Note that the Flow++ baseline used a same structure as that in a CoopFlow embodiment. By comparing the Flow++ and the CoopFlow, it is found that recruiting an extra Langevin flow helped improve the performance of the normalizing flow in terms of FID. On the other hand, although the VAEBM model achieved a better FID than the tested embodiments, but it relies on a much larger pretrained NVAE (Nouveau Variational Autoencoder) model that significantly increases its model complexity.

TABLE 8
A comparison of model sizes and FID
scores among different models.

| Model | # of Parameters | FID ↓ |
|---|---|---|
| NT-EBM (Nijkamp et al., 2020a) | 23.8M | 78.12 |
| GLOW (Kingma & Dhariwal, 2018) | 44.2M | 45.99 |
| EBM-FCE (Gao et al., 2020) | 44.9M | 37.30 |
| Flow++ (Ho et al., 2019) | 28.8M | 92.10 |
| VAEBM (Xiao et al., 2021) | 135.1M | 12.16 |
| CoopFlow(T = 30) Embodiment | 45.9M | 21.16 |
| CoopFlow(T = 200) Embodiment | 45.9M | 18.89 |
| CoopFlow(Pre) Embodiment | 45.9M | 15.80 |

### 9. Comparison with Models using Short-Run MCMC

In this section, a CoopFlow model embodiment is compared with other models that use a short-run MCMC as a flow-like generator. The baselines include (1) the single EBM with short-run MCMC starting from the noise distribution, and (ii) cooperative training of an EBM and a generic generator. In Table 9, the FID scores of different methods over different numbers of MCMC steps are reported. With the same number of Langevin steps, the CoopFlow embodiment generated much more realistic image patterns than the other two baselines. Furthermore, the results show that the CoopFlow embodiment can use fewer Langevin steps (i.e., a shorter Langevin flow) to achieve better performance.

TABLE 9
A comparison of FID scores of the short-run EBM, the CoopNets, and
a CoopFlow embodiment under different numbers of Langevin steps.

| | | # of MCMC steps | | | | | |
|---|---|---|---|---|---|---|---|
| | | 10 | 20 | 30 | 40 | 50 | 200 |
| Model | Short- | 421.3 | 194.88 | 117.02 | 140.79 | 198.09 | 54.23 |
| | run EBM | | | | | | |
| | CoopNets | 33.74 | 33.48 | 34.12 | 33.85 | 42.99 | 38.88 |
| | CoopFlow(Pre) | 16.46 | 15.20 | 15.80 | 16.80 | 15.64 | 17.94 |
| | Emb. | | | | | | |

### 10. Noise Term in the Langevin Dynamics:

While for the experiments shown in the main text, the noise term δ∈ of the Langevin equation presented in Eq. (3) by following Zhao et al. (Yang Zhao, Jianwen Xie, and Ping Li. Learning energy-based generative models via coarse-to-fine expanding and sampling. In Proceeding of the 9th International Conference on Learning Representations (ICLR), Virtual Event, 2021, which is incorporated by reference herein in its entirety; and commonly-owned U.S. patent application Ser. No. 17/478,776, Docket No. 28888-2440 (BN200929USN1)), titled “ENERGY-BASED GENERATIVE MODELS VIA COARSE-TO-FINE EXPANDING AND SAMPLING,” filed on 17 Sep. 2021, and listing Jianwen Xie, Yang Zhao, and Ping Li as inventors (which patent document is incorporated by reference herein in its entirety)) to achieve better results, here an alternative way is tried where the effect of the noise term was gradually decayed toward zero during the training process. The decay ratio for the noise term can be computed by the following:

$$decay ratio = max ( {( 1. - \frac{epoch}{K} )}^{20} , 0. ) \qquad ( 10 )$$

where K is a hyper-parameter controlling the decay speed of the noise term. Such a noise decay strategy enables the model to do more exploration in the sampling space at the beginning of the training and then gradually focus on the basins of the reachable local modes for better synthesis quality when the model is about to converge. Note that the noise term was decayed during the training stage and the noise term was removed during the testing stage, including image generation and FID calculation. Experiments were carried out on Dataset 1 and Dataset 2 using a CoopFlow(Pre) setting embodiments. The results are shown in Table 10.

TABLE 10
FID scores for the CoopFlow model embodiments trained with
gradually reducing noise term in the Langevin dynamics.

| Dataset | K | FID (no noise) | FID (decreasing noise) |
|---|---|---|---|
| Dataset 1 | 30 | 15.80 | 14.55 |
| Dataset 2 | 15 | 15.32 | 15.74 |

### 11. Comparison between CoopFlow and Short-Run EBM Via Information Geometry

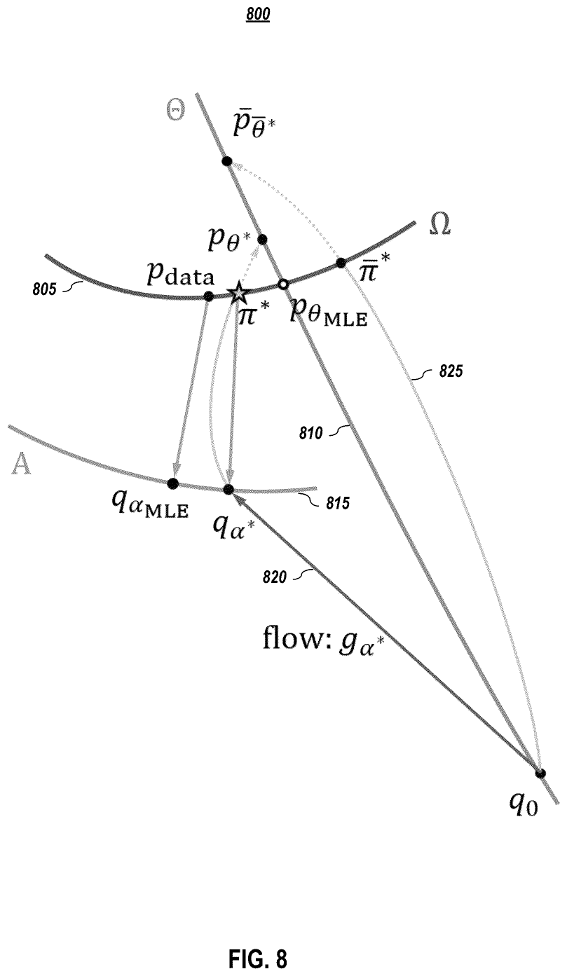

FIG. 8 illustrates the convergences of both a CoopFlow embodiment and the EBM with a short-run MCMC starting from an initial noise distribution go. The short-run EBM is defined in a more generic form as follows:

$${p}_{θ} ( x ) = \frac{1}{Z ( θ )} exp [ {f}_{θ} ( x ) ] {q}_{0} ( x ) , \qquad ( 11 )$$

which is an exponential tilting of a known reference distribution q₀(x). In general, the reference distribution may be either the Gaussian distribution or the uniform distribution. When the reference distribution is the uniform distribution, q₀ may be removed in Eq. (11). Since the initial distribution of the CoopFlow embodiment is the Gaussian distribution q₀, which is actually the prior distribution of the normalizing flow. For a convenient and fair comparison, the Gaussian distribution was used as the reference distribution of the EBM in Eq. (11). And the CoopFlow embodiment and the baseline short-run EBM used the same EBM defined in Eq. (11) in their frameworks. p̅_{θ̅} is used to denote the baseline short-run EBM and p_{θ} is used to denote the EBM component in the CoopFlow embodiment. There are three families of distributions:

Ω={p: [symbol] ₚ[h(x)]= [symbol] [h(x)]},

Θ={p_{θ}(x)=exp( [symbol] θ,h(x) [symbol] )q₀(x)/Z(θ),∀θ}, and

A={q_{α},∀α},
which are shown by the curves 805, 810, and 815, respectively in FIG. 8, which is an extension of FIG. 4 by adding the following elements:
q₀, which is the initial distribution for both the CoopFlow embodiment and the short-run EBM. It belongs to Θ because it corresponds to θ=0. q₀ is a noise distribution; thus, it is far under the curve 815. That is, it is very far from q_{α*} because q_{α*} has been already a good approximation of p_{θ*} .
g_{α*} , which is the learned transformation of the normalizing flow q_{α}, and is visualized as a mapping from q₀ to q_{α*} by a directed line segment 820.

The MCMC trajectory of the baseline short-run EBM p̅_{θ̅}, which is shown by the line 825 on the right-hand side of the curve 810. The solid part of the line 825, starting from q₀ to π̅^{*}= [symbol] _{θ̅*}q₀, shows the short-run non-mixing MCMC starting from the initial Gaussian distribution q₀ in Θ and arriving at π̅^{*} in Ω. The dotted part of the line 825 is the potential long-run MCMC trajectory that is unrealized.

By comparing the MCMC trajectories of the CoopFlow embodiment and the short-run EBM in FIG. 8, it is found that the CoopFlow embodiment has a much shorter MCMC trajectory than that of the short-run EBM, since the normalizing flow g_{α*} in the CoopFlow embodiment amortizes the sampling workload for the Langevin flow in the CoopFlow model embodiment.

### 12. More Convergence Analysis

Embodiments of the CoopFlow methodology involve two MLE learning methods: (i) the MLE learning of the EBM p_{θ}, and (ii) the MLE learning of the normalizing flow q_{α} . The convergence of each of the two learning methods has been well studied and verified in the existing literature. That is, each of them has a fixed point. The only interaction between these two MLE methods in CoopFlow embodiments is that, in each learning iteration, they feed each other with their synthesized examples and use the cooperatively synthesized examples in their parameter update formulas. To be specific, the normalizing flow uses its synthesized examples to initialize the MCMC of the EBM, while the EBM feeds the normalizing flow with its synthesized examples as training examples. The synthesized examples from the Langevin flow may be considered the cooperatively synthesized examples by the two models, and may be used to compute their learning gradients. Unlike other amortized sampling methods that uses variational learning, the EBM and normalizing flow in embodiment herein do not back-propagate each other through the cooperatively synthesized examples. They feed each other with some input data for their own training methods. That is, each learning method will still converge to a fixed point.

Now consider analysis of the convergence of a whole CoopFlow embodiment that alternates two maximum likelihood learning methods. The convergence of the objective function at each learning step is first analyzed, followed by the convergence of the whole methodology.

The convergence of CD learning of EBM. The learning objective of the EBM is to minimize the KL divergence between the EBM p_{θ} and the data distribution p_{data}. data Since the MCMC of the EBM in the model is initialized by the normalizing flow q_{α} , it follows a modified contrastive divergence method. That is, at iteration t, it has the following objective,

$${θ}^{( t + 1 )} = arg {min}_{θ} {𝔻}_{KL} ( {p}_{data} \vert \vert {p}_{θ} ) - {𝔻}_{KL} ( {𝒦}_{{θ}^{( t )}} {q}_{{α}^{( t )}} \vert \vert {p}_{θ} ) . \qquad ( 12 )$$

No matter what kind of distribution is used to initialize the MCMC, it will have a fixed point when the learning gradient of θ equals to 0, i.e.,

$${L}^{′} ( θ ) = \frac{1}{n} {\sum }_{i = 1}^{n} {∇}_{θ} {f}_{θ} ( {x}_{i} ) - \frac{1}{n} {\sum }_{i = 1}^{n} {∇}_{θ} {f}_{θ} ( {\tilde{x}}_{i} ) = 0.$$

The initialization of the MCMC affects the location of the fixed point of the learning method. The convergence and the analysis of the fixed point of the contrastive divergence algorithm has been previously studied by others.

The convergence of MLE learning of normalizing flow. The objective of the normalizing flow is to learn to minimize the KL divergence between the normalizing flow and the Langevin flow (or the EBM) because, in each learning iteration, the normalizing flow uses the synthesized examples generated from the Langevin dynamics as training data. At iteration t, it has the following objective:

$${α}^{( t + 1 )} = arg {min}_{α} {𝔻}_{KL} ( {𝒦}_{{θ}^{( t )}} {q}_{{α}^{( t )}} \vert \vert {q}_{α} ) , \qquad ( 13 )$$

which is a convergent method at each t. The convergence has been studied has been previously studied by others.

The convergence of CoopFlow. A CoopFlow embodiment alternates the above two learning methods. The EBM learning seeks to reduce the KL divergence between the EBM and the data, i.e., p_{θ}→p_{data}; while the MLE learning of normalizing flow seeks to reduce the KL divergence between the normalizing flow and the EBM, i.e., q_{α}→p_{θ}. Therefore, the normalizing flow will chase the EBM toward the data distribution gradually. Because the process p_{θ}→p_{data} will stop at a fixed point, therefore q_{α}→_{θ} will also stop at a fixed point. Such a chasing game is a contraction method, therefore the fixed point of the CoopFlow exists. Empirical evidence also supports this claim. If one uses (θ^{*}, α^{*}) to denote the fixed point of a CoopFlow embodiment, according to the definition of a fixed point, (θ^{*}, α^{*}) satisfies:

$${θ}^{*} = arg {min}_{θ} {𝔻}_{KL} ( {p}_{data} \vert \vert {p}_{θ} ) - {𝔻}_{KL} ( {𝒦}_{{θ}^{*}} {q}_{{α}^{*}} \vert \vert {p}_{θ} ) , \qquad ( 14 )$$

$${α}^{*} = arg {min}_{α} {𝔻}_{KL} ( {𝒦}_{{θ}^{*}} {q}_{{α}^{*}} \vert \vert {q}_{α} ) . \qquad ( 15 )$$

The convergence of the cooperative learning framework (CoopNets) that integrates the MLE algorithm of an EBM and the MLE algorithm of a generic generator has been verified. The CoopFlow that uses a normalizing flow instead of a generic generator has the same convergence property as that of the original CoopNets. One of the major contributions herein is to start from the above fixed-point equation to analyze where the fixed point will be in an embodiment of the learning method, especially when the MCMC is non-mixing and non-convergent. This goes beyond all the prior works about cooperative learning.

### 13. CITED DOCUMENTS

Each document cited herein is incorporated by reference herein in its entirety and for all purposes.
Michael Arbel, Liang Zhou, and Arthur Gretton, “Generalized energy based models,” In Proceedings of the 9th International Conference on Learning Representations (ICLR), Virtual Event, 2021.
Dongsheng An, Jianwen Xie, and Ping Li, “Learning deep latent variable models by short-runMCMC inference with optimal transport correction,” In Proceedings of the IEEE Conference on Computer Vision and Pattern Recognition (CVPR), pp. 15415-15424, Virtual Event, 2021.
Tian Qi Chen, Jens Behrmann, David Duvenaud, and Jorn-Henrik Jacobsen, “Residual flows for invertible generative modeling,” In Advances in Neural Information Processing Systems (NeurIPS), pp. 9913-9923, Vancouver, Canada, 2019.
Yilun Du and Igor Mordatch, “Implicit generation and modeling with energy based models,” In Advances in Neural Information Processing Systems (NeurIPS), pp. 3603-3613, Vancouver, Canada, 2019.
Yilun Du, Shuang Li, Joshua B. Tenenbaum, and Igor Mordatch, “Improved contrastive divergence training of energy-based models,” In Proceedings of the 38th International Conference on Machine Learning (ICML), pp. 2837-2848, Virtual Event, 2021.
Bin Dai and David P. Wipf, “Diagnosing and enhancing VAE models,” In Proceeding of the 7^{th} International Conference on Learning Representations (ICLR), New Orleans, LA, 2019.
Ishaan Gulrajani, Faruk Ahmed, Martin Arjovsky, Vincent Dumoulin, and Aaron C. Courville, “Improved training of Wasserstein GANs,” In Advances in Neural Information Processing Systems (NIPS), pp. 5767-5777, Long Beach, CA, 2017.
Will Sussman Grathwohl, Jacob Jin Kelly, Milad Hashemi, Mohammad Norouzi, Kevin Swersky, and David Duvenaud, “No MCMC for me: Amortized sampling for fast and stable training of energy-based models,” In Proceedings of the 9th International Conference on Learning Representations (ICLR), Virtual Event, 2021.
Ruiqi Gao, Erik Nijkamp, Diederik P. Kingma, Zhen Xu, Andrew M. Dai, and Ying Nian Wu, “Flow contrastive estimation of energy-based models,” In Proceedings of the 2020 IEEE Conference on Computer Vision and Pattern Recognition (CVPR), pp. 7515-7525, Seattle, WA, 2020.
Ruiqi Gao, Yang Song, Ben Poole, Ying Nian Wu, and Diederik P. Kingma, “Learning energy-based models by diffusion recovery likelihood,” In Proceeding of the 9th International Conference on Learning Representations (ICLR), Virtual Event, 2021.
Partha Ghosh, Mehdi S. M. Sajjadi, Antonio Vergari, Michael J. Black, and Bernhard Scholkopf, “From variational to deterministic autoencoders,” In Proceeding of the 8^{th} International Conference on Learning Representations (ICLR), Addis Ababa, Ethiopia, 2020.
Tian Han, Yang Lu, Song-Chun Zhu, and Ying NianWu, “Alternating back-propagation for generator network,” In Proceedings of the Thirty-First AAAI Conference on Artificial Intelligence (AAAI), pp. 1976-1984, San Francisco, CA, 2017.
Tian Han, Erik Nijkamp, Linqi Zhou, Bo Pang, Song-Chun Zhu, and Ying Nian Wu, “Joint training of variational auto-encoder and latent energy-based model,” In Proceedings of the 2020 IEEE Conference on Computer Vision and Pattern Recognition (CVPR), pp. 7975-7984, Seattle, WA, 2020.
(Kingma & Welling, 2014). Diederik P. Kingma and Max Welling, “Auto-encoding variational bayes,” In Proceedings of the 2^{nd} International Conference on Learning Representations (ICLR), Banff, Canada, 2014.
Diederik P. Kingma and Prafulla Dhariwal, “Glow: Generative flow with invertible 1×1 convolutions,” In Advances in Neural Information Processing Systems (NeurIPS), pp. 10236-10245, Montreal, Canada, 2018.
Tero Karras, Miika Aittala, Janne Hellsten, Samuli Laine, Jaakko Lehtinen, and Timo Aila, “Training generative adversarial networks with limited data,” In Advances in Neural Information Processing Systems (NeurIPS), Virtual Event, 2020.
Takeru Miyato, Toshiki Kataoka, Masanori Koyama, and Yuichi Yoshida, “Spectral normalization for generative adversarial networks,” In Proceeding of the 6th International Conference on Learning Representations (ICLR), Vancouver, Canada, 2018.
Erik Nijkamp, Mitch Hill, Song-Chun Zhu, and Ying Nian Wu, “Learning non-convergent nonpersistent short-run MCMC toward energy-based model,” In Advances in Neural Information Processing (NeurIPS), pp. 5233-5243, Vancouver, Canada, 2019.
Nijkamp et al., “Learning energy-based model with flow-based backbone by neural transport MCMC,” arXiv preprint arXiv:2006.06897, 2020a.
Nijkamp et al., “Learning multi-layer latent variable model via variational optimization of short run MCMC for approximate inference,” In Proceedings of the 16th European Conference on Computer Vision (ECCV, Part VI), pp. 361-378, Glasgow, UK, 2020b.
Georg Ostrovski, Will Dabney, and Remi Munos, “Autoregressive quantile networks for generative modeling,” In Proceedings of the 35th International Conference on Machine Learning (ICML), pp. 3933-3942, Stockholmsmassan, Stockholm, Sweden, 2018.
Bo Pang, Tian Han, Erik Nijkamp, Song-Chun Zhu, and Ying Nian Wu, “Learning latent space energy-based prior model,” In Advances in Neural Information Processing Systems (NeurIPS), Virtual Event, 2020.
Alec Radford, Luke Metz, and Soumith Chintala, “Unsupervised representation learning with deep convolutional generative adversarial networks,” In Proceedings of the 4th International Conference on Learning Representations (ICLR), San Juan, Puerto Rico, 2016.
Tim Salimans, Andrej Karpathy, Xi Chen, and Diederik P. Kingma,“PixelCNN++: Improving the PixelCNN with discretized logistic mixture likelihood and other modifications,” In Proceeding of the 5th International Conference on Learning Representations (ICLR), Toulon, France, 2017.
Yang Song and Stefano Ermon, “Generative modeling by estimating gradients of the data distribution,” In Advances in Neural Information Processing Systems (NeurIPS), pp. 11895-11907, Vancouver, Canada, 2019.
Yang Song and Stefano Ermon, “Improved techniques for training score-based generative models,” In Advances in Neural Information Processing Systems (NeurIPS), Virtual Event, 2020.
Yang Song, Jascha Sohl-Dickstein, Diederik P. Kingma, Abhishek Kumar, Stefano Ermon, and Ben Poole, “Score-based generative modeling through stochastic differential equations,” In Proceeding of the 9th International Conference on Learning Representations (ICLR), Virtual Event, 2021.
Jianwen Xie, Yang Lu, Ruiqi Gao, Song-Chun Zhu, and Ying Nian Wu, “Cooperative training of descriptor and generator networks,” IEEE Transactions on Pattern Analysis and Machine Intelligence (TPAMI), 42(1):27-45, 2020a.
Jianwen Xie, Zilong Zheng, and Ping Li, “Learning energy-based model with variational auto encoder as amortized sampler,” In Proceeding of the Thirty-Fifth AAAI Conference on Artificial Intelligence (AAAI), pp. 10441-10451, Virtual Event, 2021b.
Xiao Zhisheng Xiao, Karsten Kreis, Jan Kautz, and Arash Vandat, “VAEBM: A symbiosis between variational autoencoders and energy-based models,” In Proceeding of the 9th International Conference on Learning Representations (ICLR), Virtual Event, 2021.
Yang Zhao, Jianwen Xie, and Ping Li., “Learning energy-based generative models via coarse-to-fine expanding and sampling,” In Proceeding of the 9th International Conference on Learning Representations (ICLR), Virtual Event, 2021.

### H. Computing System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smartphone, phablet, tablet, etc.), smartwatch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

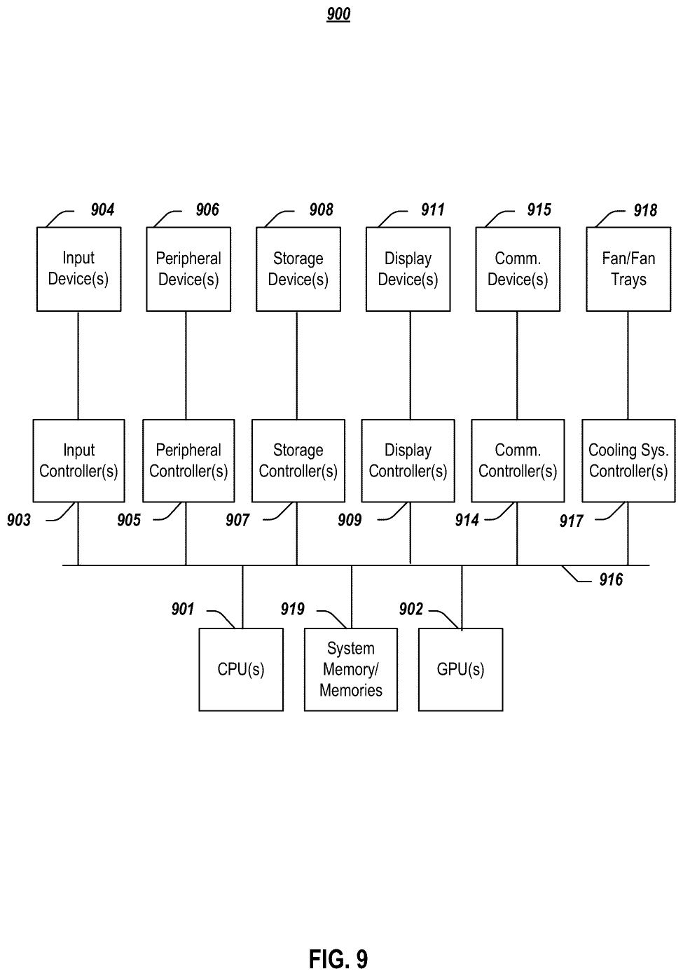

FIG. 9 depicts a simplified block diagram of an information handling system (or computing system), according to embodiments of the present disclosure. It will be understood that the functionalities shown for system 900 may operate to support various embodiments of a computing system—although it shall be understood that a computing system may be differently configured and include different components, including having fewer or more components as depicted in FIG. 9.

As illustrated in FIG. 9, the computing system 900 includes one or more CPUs 901 that provide computing resources and control the computer. CPU 901 may be implemented with a microprocessor or the like, and may also include one or more graphics processing units (GPU) 902 and/or a floating-point coprocessor for mathematical computations. In one or more embodiments, one or more GPUs 902 may be incorporated within the display controller 909, such as part of a graphics card or cards. Thy system 900 may also include a system memory 919, which may comprise RAM, ROM, or both.

A number of controllers and peripheral devices may also be provided, as shown in FIG. 9. An input controller 903 represents an interface to various input device(s) 904. The computing system 900 may also include a storage controller 907 for interfacing with one or more storage devices 908 each of which includes a storage medium such as magnetic tape or disk, or an optical medium that might be used to record programs of instructions for operating systems, utilities, and applications, which may include embodiments of programs that implement various aspects of the present disclosure. Storage device(s) 908 may also be used to store processed data or data to be processed in accordance with the disclosure. The system 900 may also include a display controller 909 for providing an interface to a display device 911, which may be a cathode ray tube (CRT) display, a thin film transistor (TFT) display, organic light-emitting diode, electroluminescent panel, plasma panel, or any other type of display. The computing system 900 may also include one or more peripheral controllers or interfaces 905 for one or more peripherals 906. Examples of peripherals may include one or more printers, scanners, input devices, output devices, sensors, and the like. A communications controller 914 may interface with one or more communication devices 915, which enables the system 900 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 900 comprises one or more fans or fan trays 918 and a cooling subsystem controller or controllers 917 that monitors thermal temperature(s) of the system 900 (or components thereof) and operates the fans/fan trays 918 to help regulate the temperature.

In the illustrated system, all major system components may connect to a bus 916, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A computer-implemented method comprising:
initializing normalizing flow parameters for a normalizing flow neural network and energy-based model parameters for an energy-based model (EBM); and
performing a set of steps until a stop condition is reached, the set of steps comprising:
for each training signal sampled from an unknown data distribution:
generating an initial signal sampled from a [normal] distribution;
transforming the initial signal using a normalizing flow neural network to obtain a normalized flow-generated signal; and
generating, via a Markov chain Monte Carlo (MCMC) sampling process, a synthesized signal using the EBM and using the normalized flow-generated signal as an initial starting point for the MCMC sampling process;
using a set of synthesized signals and a set of normalized flow-generated signals corresponding to the set of synthesized signals to update the normalizing flow parameters for the normalizing flow neural network; and
updating the energy-based model parameters for the energy-based model by using a comparison comprising the set of synthesized signals and a set of training signals corresponding to the set of synthesized signals.

2. The computer-implemented method of claim 1 wherein updating the normalizing flow parameters for the normalizing flow neural network is performed via gradient ascent.

3. The computer-implemented method of claim 1 wherein the step of updating the energy-based model parameters for the energy-based model by using a comparison comprising the set of synthesized signals and a set of training signals corresponding to the set of synthesized signals comprises:
determining a learning gradient comprising a different in values obtained using values from the EBM given the set of training signals as inputs and values from the EBM given the set of synthesized signals as inputs to the EBM.

4. The computer-implemented method of claim 1 wherein:
the set of training signals represents a set of training images; and
the set of synthesized signals represents a set of synthesized images.

5. The computer-implemented method of claim 1 further comprising:
responsive to a stop condition being reached, outputting a final version of the normalizing flow parameters for the normalizing flow neural network and a final version of the energy-based model parameters for the energy-based model.

6. The computer-implemented method of claim 3 wherein the stop condition comprising an iteration number having been met, a processing time having been met, an amount of data processing having been met, a number of processing iterations having been met, or a convergence condition or conditions having been met.

7. The computer-implemented method of claim 1 wherein the MCMC sampling process is an iterative process with a finite number of Langevin steps of a Langevin flow.

8. A computer-implemented method comprising:
generating a set of initial signals, which are sampled from a distribution;
transforming the initial signals by normalizing flow using a normalizing flow neural network comprising normalizing flow parameters to obtain a set of normalized flow-generated signals corresponding to the set of initial signals;
for each normalized flow-generated signal of the set of normalized flow-generated signals, generating a synthesized signal by performing a Langevin flow that is initialized with the normalized flow-generated signal;
updating of the normalizing flow parameters of the normalizing flow neural network by treating the synthesized signals generated by the Langevin flow as training data; and
updating of the Langevin flow according to a learning gradient of a model used in the Langevin flow using the synthesized signals generated and a set of observed signals.

9. The computer-implemented method of claim 8 wherein the model for the Langevin flow is an energy-based model.

10. The computer-implemented method of claim 8 wherein the steps of claim 8 represent an iteration and the method further comprises:
repeating the steps of claim 8 for a set of iterations until a stop condition is reached.

11. The computer-implemented method of claim 10 further comprising:
responsive to a stop condition being reached, outputting a final version of the normalizing flow parameters for the normalizing flow neural network and a final version of parameters for model used in the Langevin flow.

12. The computer-implemented method of claim 8 wherein the learning gradient of the model used in the Langevin flow is obtained by performing steps comprising:
determining a different or differences in values obtained using values from the model given the set of training signals as inputs and values from the model given the set of synthesized signals as inputs to the model.

13. The computer-implemented method of claim 8 wherein:
the set of training signals represents a set of training images; and
the set of synthesized signals represents a set of synthesized images.

14. The computer-implemented method of claim 8 wherein a normalizing flow neural network is pretrained.

15. A system comprising:
one or more processors; and
a non-transitory computer-readable medium or media comprising one or more sets of instructions which, when executed by at least one of the one or more processors, causes steps to be performed comprising:
generate a set of initial signals, which are sampled from a distribution;
transforming the initial signals by normalizing flow using a normalizing flow neural network comprising normalizing flow parameters to obtain a set of normalized flow-generated signals corresponding to the set of initial signals;
for each normalized flow-generated signal of the set of normalized flow-generated signals, generating a synthesized signal by performing a Langevin flow that is initialized with the normalized flow-generated signal;
updating of the normalizing flow parameters of the normalizing flow neural network by treating the synthesized signals generated by the Langevin flow as training data; and
updating of the Langevin flow according to a learning gradient of a model used in the Langevin flow using the synthesized signals generated and a set of observed signals.

16. The system of claim 15 wherein the model for the Langevin flow is an energy-based model.

17. The system of claim 15 wherein the steps of claim 15 represent an iteration and the non-transitory computer-readable medium or media further comprises one or more sets of instructions which, when executed by at least one of the one or more processors, causes steps to be performed comprising:
repeating the steps of claim 15 for a set of iterations until a stop condition is reached.

18. The system of claim 15 wherein the non-transitory computer-readable medium or media further comprises one or more sets of instructions which, when executed by at least one of the one or more processors, causes steps to be performed comprising:
responsive to a stop condition being reached, outputting a final version of the normalizing flow parameters for the normalizing flow neural network and a final version of parameters for model used in the Langevin flow.

19. The system of claim 15 wherein the learning gradient of the model used in the Langevin flow is obtained by performing steps comprising:
determining a different or differences in values obtained using values from the model given the set of training signals as inputs and values from the model given the set of synthesized signals as inputs to the model.

20. The system of claim 15 wherein:
the set of training signals represents a set of training images; and
the set of synthesized signals represents a set of synthesized images.
